(19) United States
(12) Patent Application Publication
(10) Pub. No.: US 2016/0340952 A1
(43) Pub. Date: Nov. 24, 2016

(54) SLIDING DOOR WITH MAGNETIC SUPPORT

(71) Applicants: Glancarlo BRUN, Thiene (VI) (IT); MGT INDUSTRIES S.R.L., Schio (VI) (IT)

(72) Inventor: Giancarlo Brun, Thiene (VI) (IT)

(73) Assignee: MGT INDUSTRIES S.R.L., Schio (VI) (IT)

(21) Appl. No.: 15/112,172

(22) PCT Filed: Jan. 14, 2015
(86) PCT No.: PCT/IB2015/050275

§ 371 Date: Jul. 16, 2016

(30) Foreign Application Priority Data
Jan. 17, 2014 (IT) VI2014A000008

(51) Int. Cl. E05D 15/06; E05F 5/00; E05F 1/16

(52) U.S. Cl. CPC E05D 15/0626; E05D 15/063; E05D 15/0656; E05D 15/0647; E05D 15/066; E05F 1/16; E05F 5/003; E05D 2015/0695; E05Y 2900/114; E05Y 2900/132; E05Y 2900/20; E05Y 2900/30

(57) ABSTRACT

The invention is a sliding door (1) comprising a door leaf (2) and a guide (3) that allows the door leaf (2) to slide along the guide (3), wherein the sliding door (1) furthermore comprises first coupling means (4) and second coupling means (5, 5′) suited to couple the door leaf (2) with the guide (3). Said first coupling means (4) comprise one or more magnetic elements (6), in such a way as to exert a magnetic force (FM) between the first coupling means (4) and the second coupling means (5, 5′) so that the weight of the door leaf (2) is at least partially supported through the magnetic force (FM). The invention concerns also the use of one or more magnetic elements (6, 8, 8′, 8a) in a sliding door (1), a door kit comprising one or more magnetic elements (6, 8, 8′, 8a) and a guide (3), as well as a furnishing element like, for example, a wardrobe, a cupboard, a piece of office furniture, a fridge, a shower cubicle, a bathtub.

### TECHNICAL FIELD OF THE INVENTION

The present invention concerns the building construction and the furnishing sectors. In particular, the present invention concerns the field of doors for interiors and/or exteriors and of doors for furnishing elements like, for example, wardrobes, cupboards, office furniture, fridges, shower cubicles, bathtubs and similar elements. Even more particularly, the present invention concerns the sector of doors of the sliding type.

### BACKGROUND OF THE INVENTION

Sliding doors have been used for some time now in very many sectors, from the building construction sector to the furniture sector. Sliding doors are particularly suited to be used in small places, where, for example, it is desirable to be able to use the space occupied by the door when it is open. These doors are generally maintained in place thanks to the presence of one or two guides, one positioned at the top of the door and if necessary one positioned at the bottom of the door. These guides, fixed to the support on which the door is mounted, are made in such a way that the sliding door leaf is inserted in them. The door leaf can slide on the guides, through suitable means, for example wheels or sliding blocks. These means, if arranged at the top of the door, support its entire weight. The operations necessary to assemble and install sliding doors can often involve several problems due, for example, to the fact that it is difficult to insert the door leaf and the supporting and/or sliding means, for example wheels or sliding blocks, in the guides.

A further technical problem lies in that it is desirable to make sliding doors as compact as possible, reducing the dimensions of their components.

Finally, in the sector a problem is certainly represented by the need to make sliding doors so that the operations necessary to assemble and install them are as simple as possible.

Thus, it is one of the objects of the present invention to provide sliding doors that allow the problems posed by the systems known in the art to be overcome.

### SUMMARY OF THE INVENTION

The present invention is based on the idea that it is desirable to provide a sliding door comprising a door leaf and a guide, so that the door leaf can slide along the guide, and such that the weight of the door leaf is entirely or at least partially supported by means of a magnetic force. Based on the present invention, the weight of the door leaf can be entirely supported through a magnetic force. Furthermore, based on the present invention the weight of the door leaf can be supported by means of a magnetic force both when the door leaf is still, for example when the door is open or closed, and when the door leaf is sliding along the guide, for example while the door is being opened and closed.

The sliding door according to the present invention can be an inner or an outer door of a building, or the door of a furnishing element, for example a wardrobe, a cupboard, a piece of office furniture, a fridge, a shower cubicle, a bathtub or a similar element.

According to an embodiment of the present invention, a sliding door is provided which comprises a door leaf and a guide and allows the door leaf to slide along the guide, wherein the sliding door furthermore comprises first coupling means and second coupling means suited to couple the door leaf with the guide, and is such that the first coupling means comprise one or more magnetic elements, in such a way as to exert a magnetic force between the first coupling means and the second coupling means, so that the weight of the door leaf is supported through the magnetic force. In this way, during its sliding movement along the guide, the sliding door leaf is completely supported by the magnetic force generated by the magnetic elements. This makes it possible to eliminate further supporting elements for the door leaf that serve to fix the door leaf to the guide on which it slides and that support its weight. A sliding door made in this way advantageously occupies less space than a sliding door of the known type, thanks to the elimination of the elements mentioned above. Furthermore, by exploiting the magnetic interaction between the first and the second coupling means, it is possible to considerably simplify the procedure for assembling and installing the sliding door. The magnetic force between the first coupling means and the second coupling means, in fact, can be exploited in order to easily place the sliding door leaf in position with respect to the guide.

According to a further embodiment of the present invention, the magnetic force that supports the weight of the door leaf is of the attractive type. In this way, the positioning of the door leaf in the guide during the assembly of the door is considerably simplified. In fact, it is sufficient to bring the door leaf near the guide and allow the attractive magnetic force exerted by the magnets on the second coupling means to automatically place the door leaf in its seat. Preferably, the door leaf comprises the first coupling means that comprise one or more magnetic elements.

Furthermore, according to a further embodiment of the present invention, the guide comprises the second coupling means. The second coupling means can advantageously be made in a metallic material or a paramagnetic material or a ferromagnetic material. The second coupling means can, for example, comprise a strip or a wire made of said material. The second coupling means can also be structured in such a way as to comprise cavities or slits made, for example, in the metallic material or the paramagnetic material or the ferromagnetic material, and structured in such a way as to house the magnetic elements of the first coupling means during the sliding movement.

According to a further embodiment of the present invention, the magnetic elements of the first coupling means are all oriented in a consistent manner, that is, with the same poles all directed towards the second coupling means.

According to a further embodiment of the present invention, the magnetic force that supports the weight of the door leaf is of the repulsive type, so that the weight of the door leaf is supported through magnetic levitation. In this way, the positioning of the door leaf in the guide during the door assembly operations is considerably simplified. In fact, once the door leaf has been brought near the guide and fixed to it, the magnetic force exerted by the magnets on the second coupling means advantageously supports the weight of the door leaf automatically through magnetic levitation. Preferably, the second coupling means are mounted on the floor. The second coupling means can advantageously comprise a plurality of magnetic elements, all oriented in a consistent manner and in the opposite manner with respect to the poles of the magnetic elements of the first coupling means, in such a way as to generate the repulsive force.

According to a further embodiment of the present invention, the magnetic force comprises a vertical component, parallel to the weight force of the door leaf, and a horizontal component, perpendicular to the vertical component, wherein the horizontal component is different from zero, in such a way as to stabilize the door leaf during its sliding movement along the guide. In this embodiment of the invention, the component of the magnetic force parallel to the weight force supports the weight of the door leaf, while the component of the magnetic force perpendicular to it advantageously contributes to maintaining the door leaf firmly in its seat both while it slides and when it is still in any position along its stroke. According to a further embodiment of the present invention, the guide forms an angle β with respect to the surface of the ground, in such a way as to automatize the closing movement of the sliding door with magnetic support.

According to a further embodiment of the present invention, the first coupling means and/or the second coupling means are configured so that the magnetic elements are not in direct physical contact with the second coupling means. This facilitates the sliding movement of the door leaf with respect to the guide. In particular, in this way it is possible to prevent the magnetic force between the first coupling means and the second coupling means from being excessively high and thus from hindering the sliding movement of the door leaf along the guide.

According to a further embodiment of the present invention, the first coupling means and/or the second coupling means are configured so that the magnetic elements are in direct physical contact with the second coupling means. In this case, the magnetic elements and/or the second coupling means are preferably covered with a layer of material with a low friction coefficient, in order to facilitate the sliding movement of the door leaf along the guide.

According to a further embodiment of the present invention, the first coupling means and/or the second coupling means comprise material with a low friction coefficient, for example Teflon or self-lubricating plastics like Arnite, Vulcolon or POM, in such a way as to facilitate the sliding movement of the door leaf along the guide. Preferably, the first coupling means comprise a surface in contact with the second coupling means and this surface comprises material with a low friction coefficient.

According to a further embodiment of the present invention, the first coupling means and/or the second coupling means comprise one or more rolling means, for example wheels, in such a way as to facilitate the sliding movement of the door leaf along the guide. The first coupling means can advantageously comprise grooves in which the rolling means are housed. The rolling means facilitate the sliding movement of the door leaf along the guide, especially in the cases where the magnetic force between the first coupling means and the second coupling means is particularly high and, since the weight of the sliding door leaf is supported by the magnetic force, the rolling means can advantageously be made in such a way as to support only very limited efforts. Furthermore, the rolling means can be configured in such a way as to prevent any direct contact between the one or more magnetic elements of the first coupling means and the second coupling means. The rolling means can therefore also serve as spacers between the one or more magnetic elements of the first coupling means and the second coupling means.

According to a further embodiment of the present invention, the rolling means comprise the magnetic elements. In this way it is possible to simultaneously optimize both the support of the door leaf weight and the sliding movement of the door leaf with respect to the guide. The magnetic elements can be arranged on one or more of the surfaces of the rolling means. Alternatively, the magnetic elements can be integrated in the rolling means. According to a further alternative solution, the rolling means are entirely made in a magnetic material.

According to a further embodiment of the present invention, the rolling means are arranged in such a way that they roll along a plane that is parallel to the plane of the ground.

According to a further embodiment of the present invention, the guide comprises a raceway intended to allow the safe movement of the rolling means inside it and to prevent them from moving along the direction perpendicular to the sliding direction of the door leaf.

According to a further embodiment of the present invention, the second coupling means comprise one or more cavities or one or more slits suited to house the magnetic elements of the first coupling means during the sliding movement. In this way, the magnetic elements of the first coupling means can be guided by the second coupling means during the sliding movement.

According to a further embodiment of the present invention, the door leaf comprises elastic elements suited to automatize the door opening and/or closing operation. In this way, once the opening and/or closing operation has been started, the sliding door opens and/or closes automatically.

According to a further embodiment of the present invention, the door furthermore comprises shock-absorbing elements suited to properly slow down the sliding movement of the door leaf along the guide during the door opening and/or closing movement. In this way, the door does not slam abruptly when it is closed and/or opened.

According to a further embodiment of the present invention, the door comprises safety means suited to limit the downward movement of the door leaf in order to prevent it from slipping out of the guide. The safety means are particularly advantageous to prevent the door leaf from slipping out of the guide, for example due to impacts against the door leaf itself.

According to a further embodiment of the present invention, the safety means are of the skirt type, which means that they comprise a sheet, for example a thin sheet that can be long and narrow and that can slide with respect to the door leaf in such a way as to project from the door leaf at different heights, in order to allow the maximum distance between the lower end of the door leaf and the ground to be adjusted. In this way, it is possible to effectively prevent the door leaf from slipping out of its seat and moving downwards, for example as a consequence of accidental impacts against the door leaf itself.

According to a further embodiment of the present invention, the guide is provided with a projecting element that can be inserted in a cavity created in the first coupling means, so that the door leaf cannot slip out of its seat and move downwards, for example as a consequence of accidental impacts against the door leaf itself.

According to a further embodiment of the present invention, one or more magnetic elements are used in a sliding door comprising a door leaf and a guide and allowing the door leaf to slide along the guide, in such a way as to generate a magnetic force suited to support the weight of the door leaf. This makes it possible to eliminate further supporting elements of the door leaf that serve to fix the door leaf to the guide in which it slides and that support its weight. A sliding door made in this way advantageously occupies less space than a sliding door of the known type, thanks to the elimination of the elements mentioned above. Furthermore, by exploiting the magnetic force generated through the magnetic elements it is possible to considerably simplify the procedure for assembling and installing the sliding door. The magnetic force, in fact, can be exploited to easily place the sliding door leaf in position with respect to the guide.

According to a further embodiment of the present invention, the guide comprises a snap-on cover that allows the sliding door to be installed frontally.

According to a further embodiment of the present invention, the first coupling means comprise a carriage comprising rolling means.

According to a further embodiment of the present invention, one or more magnetic elements are used in sliding doors according to the embodiments of the present invention.

In any embodiment, the sliding door with magnetic support may comprise also safety means intended to ensure that the door leaf does not slip out of its seat and become detached.

### BRIEF DESCRIPTION OF THE DRAWINGS

The present invention is described here below with reference to the attached figures, in which the same reference numbers and/or signs indicate the same parts and/or similar parts and/or corresponding parts of the system.

FIG. 1 schematically shows a sliding door with magnetic support according to an embodiment of the present invention, in a front view (FIG. 1A) and in a sectional view along a plane that is perpendicular to the sliding plane of the door leaf (FIG. 1B).

FIG. 2 schematically shows a detail of a sliding door with magnetic support according to an embodiment of the present invention, in a sectional view along a plane that is perpendicular to the sliding plane of the door leaf.

FIG. 3 schematically shows a detail of a sliding door with magnetic support according to a further embodiment of the present invention, in a sectional view along a plane that is perpendicular to the sliding plane of the door leaf.

FIG. 3.1 schematically shows a detail of a sliding door with magnetic support according to a further embodiment of the present invention, in a sectional view along a plane that is perpendicular to the sliding plane of the door leaf. A part of the detail is enlarged.

FIG. 4 schematically shows a detail of a sliding door with magnetic support according to a further embodiment of the present invention, in a sectional view along a plane that is perpendicular to the sliding plane of the door leaf.

FIG. 5 schematically shows a detail of a sliding door with magnetic support according to a further embodiment of the present invention, in a sectional view along a plane that is perpendicular to the sliding plane of the door leaf.

FIG. 6 schematically shows a detail of a sliding door with magnetic support according to a further embodiment of the present invention, in a sectional view along a plane that is perpendicular to the sliding plane of the door leaf.

FIG. 7 schematically shows a detail of a sliding door with magnetic support according to a further embodiment of the present invention, in a sectional view along a plane that is perpendicular to the sliding plane of the door leaf.

FIG. 7.1 schematically shows a detail of a sliding door with magnetic support according to a further embodiment of the present invention, in a sectional view along a plane that is perpendicular to the sliding plane of the door leaf. A part of the detail is enlarged.

FIG. 8 schematically shows a detail of a sliding door with magnetic support according to a further embodiment of the present invention, in a sectional view along a plane that is perpendicular to the sliding plane of the door leaf.

FIG. 9 schematically shows the resolution of the magnetic force exerted by the magnetic elements into its parallel and perpendicular components with respect to the weight force of the door leaf, according to an embodiment of the present invention.

FIG. 10 schematically shows a detail of a sliding door with magnetic support according to a further embodiment of the present invention, in a sectional view along a plane that is perpendicular to the sliding plane of the door leaf.

FIG. 10.1 schematically shows a detail of a sliding door with magnetic support according to a further embodiment of the present invention, in a sectional view along a plane that is perpendicular to the sliding plane of the door leaf. A part of the detail is enlarged.

FIG. 10.2 schematically shows a detail of a sliding door with magnetic support according to a further embodiment of the present invention, in a sectional view along a plane that is perpendicular to the sliding plane of the door leaf.

FIG. 11 schematically shows a detail of a sliding door with magnetic support according to a further embodiment of the present invention, in a sectional view along a plane that is perpendicular to the sliding plane of the door leaf.

FIG. 12 schematically shows a detail of a sliding door with magnetic support according to a further embodiment of the present invention, in a sectional view along a plane that is perpendicular to the sliding plane of the door leaf.

FIG. 13 schematically shows a detail of a sliding door with magnetic support according to a further embodiment of the present invention, in a sectional view along a plane that is perpendicular to the sliding plane of the door leaf.

FIG. 14 schematically shows a detail of a sliding door with magnetic support according to a further embodiment of the present invention, in a sectional view along a plane that is perpendicular to the sliding plane of the door leaf.

FIG. 15 schematically shows a detail of a sliding door with magnetic support according to a further embodiment of the present invention, in a sectional view along a plane that is perpendicular to the sliding plane of the door leaf.

FIG. 16 schematically shows a detail of a sliding door with magnetic support according to a further embodiment of the present invention, in a sectional view along a plane that is perpendicular to the sliding plane of the door leaf.

FIG. 16.1 schematically shows a detail of a sliding door with magnetic support according to a further embodiment of the present invention, in a sectional view along a plane that is perpendicular to the sliding plane of the door leaf.

FIG. 17 schematically shows a front view of a sliding door with magnetic support according to a further embodiment of the present invention, wherein the weight of the door leaf is supported through magnetic levitation.

FIG. 18 schematically shows a detail of a sliding door with magnetic support according to a further embodiment of the present invention, in a sectional view along a plane that is perpendicular to the sliding plane of the door leaf, and wherein the weight of the door is supported through magnetic levitation.

FIG. 19 schematically shows a detail of a sliding door with magnetic support according to a further embodiment of the present invention, in a sectional view along a plane that is perpendicular to the sliding plane of the door leaf, and wherein the weight of the door is supported through magnetic levitation.

FIG. 20 schematically shows a detail of a sliding door with magnetic support according to a further embodiment of the present invention, in a sectional view along a plane that is perpendicular to the sliding plane of the door leaf, and wherein the weight of the door is supported through magnetic levitation.

FIG. 21 schematically shows a detail of a sliding door with magnetic support according to a further embodiment of the present invention, in a sectional view along a plane that is perpendicular to the sliding plane of the door leaf, and wherein the weight of the door is supported through magnetic levitation.

FIG. 22A schematically shows a detail of an open sliding door with magnetic support according to a further embodiment of the present invention, in a sectional view along a plane that is perpendicular to the sliding plane of the door leaf (left) and in a front view (right).

FIG. 22B schematically shows a detail of the sliding door with magnetic support shown in FIG. 22A, almost closed, in a sectional view along a plane that is perpendicular to the sliding plane of the door leaf (left) and in a front view (right).

FIG. 23 schematically shows a detail of an almost closed sliding door with magnetic support according to a further embodiment of the present invention, in a sectional view along a plane that is perpendicular to the sliding plane of the door leaf (left) and in a front view (right).

FIG. 24 schematically shows a sliding door with magnetic support according to a further embodiment of the present invention, in a front view (FIG. 24A) and in a sectional view along a plane that is perpendicular to the sliding plane of the door leaf (FIG. 24B). A detail of the sliding door is enlarged.

FIG. 25A schematically shows a 3D view of a detail of the sliding door with magnetic support shown in FIG. 24.

FIG. 25B schematically shows a 3D view of a detail of the sliding door with magnetic support shown in FIG. 24.

FIG. 26 schematically shows a 3D view of a detail of the sliding door with magnetic support shown in FIG. 24.

FIG. 27 schematically shows a 3D view of a detail of the sliding door with magnetic support shown in FIG. 24.

FIG. 28 schematically shows a detail of the sliding door with magnetic support shown in FIG. 24.

### DETAILED DESCRIPTION OF THE INVENTION

The present invention is described here below with reference to particular embodiments illustrated in the attached drawings. However, the present invention is not limited to the particular embodiments illustrated in the following detailed description and represented in the figures, rather, the embodiments illustrated herein simply exemplify the various aspects of the present invention, the scope of which is defined in the claims. Further modifications and variants of the present invention will be clear to the expert in the art.

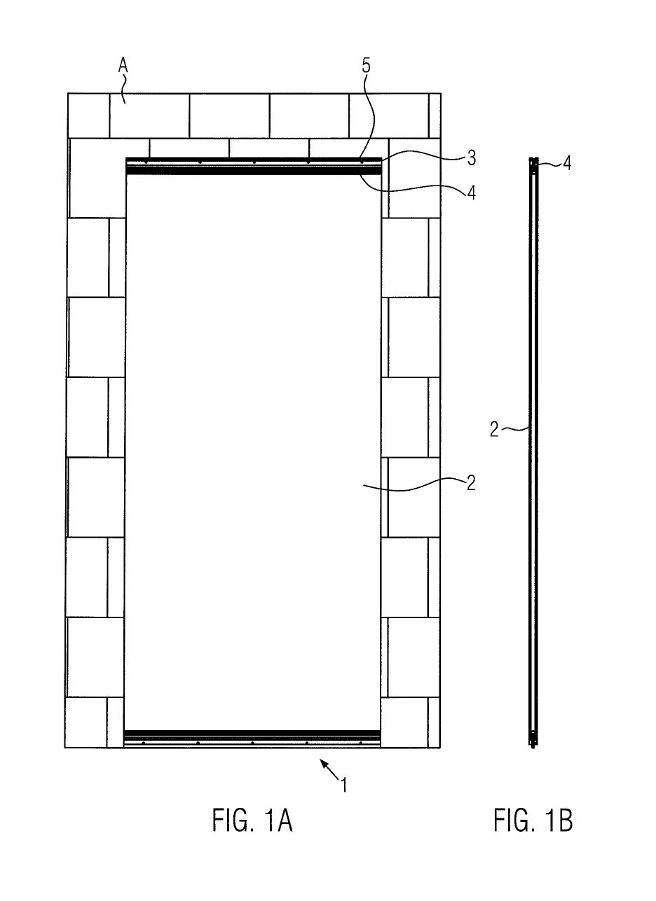

FIG. 1A schematically shows a front view of a sliding door with magnetic support 1, carried out according to an embodiment of the present invention and mounted on a supporting element A.

For example, said supporting element A can be an inner or outer wall of a building or the frame or casing of a furnishing element, for example of a wardrobe, a cupboard, a piece of office furniture, a fridge, a shower cubicle or a bathtub. The supporting element A may comprise a doorpost and/or a door frame. The sliding door 1 comprises a door leaf 2 and a guide 3. The door leaf 2 slides along the guide 3.

The door leaf 2 comprises a panel 7. The panel 7 can be made in different materials, for example glass, wood, plastic or similar materials. The panel 7 can be, for example, an element in a single block with or without a section bar for coupling the panel to other elements of the sliding door, or a double-glazing panel, meaning a panel formed by two glass panes separated by a layer of a suitable gas, for example air or a noble gas.

The door leaf 2 furthermore comprises the first coupling means 4. The first coupling means 4 comprise one or more magnetic elements 6. The magnetic elements 6 can advantageously be in the shape of a parallelepiped or a cylinder. The guide 3 is fixed to the support A on which the door 1 is mounted, through suitable fixing means, for example screws or nails or a suitable glue or silicone material. The guide 3 makes it possible to connect the door 1 to the support A. The guide 3 can be fixed to the support A over its entire length or only at its side ends. The guide can be mounted in such a way that it is parallel to the ground or inclined with respect to it.

The magnetic elements 6 are positioned on the side of the first coupling means 4 facing towards the guide 3.

The guide 3 comprises second coupling means 5. The magnetic elements 6 of the first coupling means 4 exert a magnetic force with respect to the second coupling means 5, so that the weight of the door leaf 2 is supported through this magnetic force. The second coupling means 5 can be, for example, the portion of the guide 3 facing towards the first coupling means 4. The second coupling means 5 can be, furthermore, one or more elements properly fixed to the guide 3, for example a suitable foil, cable, wire, strip or the like. The guide 3 can, for example, comprise a plastic material or wood, and the second coupling means comprise a material that is affected by the magnetic force generated by the magnetic elements 6 of the first coupling means, for example a metallic material, a ferromagnetic material or a paramagnetic material. The moving system between the door leaf 2 and the guide 3 can be a sliding system, a rolling system or a mixed system. In the first case, the first and the second coupling means 4 and 5 are kept in direct contact with each other by the magnetic force exerted by the magnetic elements 6 on the second coupling means 5. In other words, during the sliding movement the first coupling means 4 slide along the second coupling means while remaining in contact with them. For example, one or more surfaces of the first coupling means 4 slides/slide remaining in contact with one or more surfaces of the second coupling means 5.

Alternatively, the moving system between the door leaf 2 and the guide 3 can be a rolling system. In this case the first coupling means comprise rolling means 8, for example wheels. In this type of configuration, the rolling means 8 are kept in direct contact with the second coupling means 5 by the magnetic force exerted by the magnetic elements 6 of the first coupling means 4 on the second coupling means 5. The rolling means can be fixed to the first coupling means 4 and roll on one or more surfaces of the second coupling means 5. The second coupling means 5 may comprise rails, in which the rolling means 8 can be inserted, in such a way as to properly control the movement of the door leaf 2 with respect to the guide 3. The rolling means 8, in all the embodiments in which they are included, do not support, not even partially, the weight of the sliding door leaf 2, which is entirely supported by the magnetic elements 6. In fact, the rolling means have the function of facilitating the relative movement between the door leaf 2 and the guide 3.

The magnetic interaction between the magnetic elements 6 of the first coupling means and the second coupling means is briefly described here below.

Supposing, to simplify the calculation, that each magnetic element 6 of the first coupling means exerts a magnetic force FM only on the point of the second coupling means 5 along the perpendicular to the ground, then said magnetic force exerted on said point is proportional to the value of the magnetic field in that point. This value is inversely proportional to the distance d of the magnetic element 6 from the point in question. If the first coupling means 4 comprise n identical magnetic elements 6, then the total force exerted by the magnetic elements 6 on the second coupling means 5 can be approximated by the formula nFM.

If the weight of the door leaf 2 of the sliding door 1 is indicated by FP, in order for the door leaf to be supported and not to fall from its seat, ideally we should have:

nF//,M>>FP,

where F//,M is the component of the magnetic force that is parallel to the weight force. More particularly, the larger the magnetic force nF//,M with respect to the weight force of the door leaf 2, the smaller the risk of it moving from its seat and falling down.

However, the dynamic friction force between the first and the second coupling means 4 and 5 or between the second coupling means 5 and the rolling means 8 increases as the magnetic force between the first and the second coupling means 4 and 5 increases.

In particular, in the case where the system is a sliding system, that is, in the case where the first coupling means 4 slide in contact with the second coupling means 5, the dynamic sliding friction force is given by:

FAS=μS×(nF//,M−FP) (1),

where μS is the sliding friction coefficient between the materials of which the first and the second coupling means 4 and 5 are made.

In the case where the second coupling means 5 are in contact with the rolling means 8, the dynamic rolling friction force is given by:

FAR=μR×(nF//,M−FP)/R (2),

where μR is the rolling friction coefficient between the materials of which the second coupling means 5 and the rolling means 8 are made and R is the radius of the latter.

The formulas (1) and (2) show that as the difference between the magnetic force and the weight force of the door leaf increases, the friction force increases and consequently a higher force will be needed to move the door leaf 2 with respect to the guide 3 in order to allow the sliding door 1 to be opened and closed.

The above clearly shows that the optimal condition for a correct use of the sliding door 1 occurs when

nF//,M>FP (3),

so that the magnetic force is sufficient to maintain the door in its seat, but does not hinder its sliding movement.

The magnetic force can advantageously be increased, thus preventing the door from falling down, if the friction force is kept low, for example by selecting, for the first and/or the second coupling means 4 and 5, such materials that the friction coefficient between them is as low as possible. For example, the first coupling means 4 and/or the second coupling means 5 may comprise a material with a low friction coefficient, for example Teflon or self-lubricating plastics like Arnite, Vulcolon or POM, in such a way as to facilitate the sliding movement of the door leaf 2 along the guide 3.

Moreover, to further facilitate the sliding movement of the door leaf 2, it is possible to proceed in such a way that the magnetic elements 6 and the second coupling means 5 on which they exert the magnetic force are not in direct contact, but are kept at a suitable predefined distance d from each other. For example, the first coupling means 4 may comprise cavities that accommodate the magnetic elements 6, in such a way that the magnetic elements 6 are not in direct physical contact with the second coupling means 5, but on the contrary are at a predefined distance d from them. Alternatively, in some embodiments of the invention the magnetic elements 6 can also be in direct contact with the second coupling means.

The insertion of the door leaf 2 in its seat inside the guide 3 is carried out in a very simple manner, by moving the door leaf 2 near the guide 3 and letting the attractive magnetic force exerted by the magnetic elements 6 on the second coupling means 5, in the guide 3, place the door leaf 2 automatically in position. This is made particularly easy by the shape of the guide 3. The guide 3, in fact, can be in the shape of an overturned U that can also be asymmetrical. More particularly, asymmetrical means that the two legs of the overturned U can have two different lengths. The insertion of the door leaf 2 in its seat inside the guide 3 is carried out on the side of the guide 3 corresponding to the shorter leg of the U. In this way, the door leaf 2 can be installed in its seat frontally, in a quick and easy manner. Obviously, this considerably facilitates the assembly operations that, in the case of sliding doors, can often be complicated due to the limited spaces in which they are performed.

Once the door leaf 2 of the sliding door 1 has been placed in its seat, its weight is entirely supported by the attractive magnetic force exerted by the magnetic elements 6 on the second coupling means 5. The weight of the door leaf 2 is supported by the magnetic force over its entire stroke along the guide 3.

FIG. 1B shows the door shown in FIG. 1A, in a sectional view along a plane that is perpendicular to the sliding plane of the door leaf. It can be observed that the first coupling means 4, comprising the magnetic elements 6, are positioned on the top end of the panel 7 of the door leaf 2.

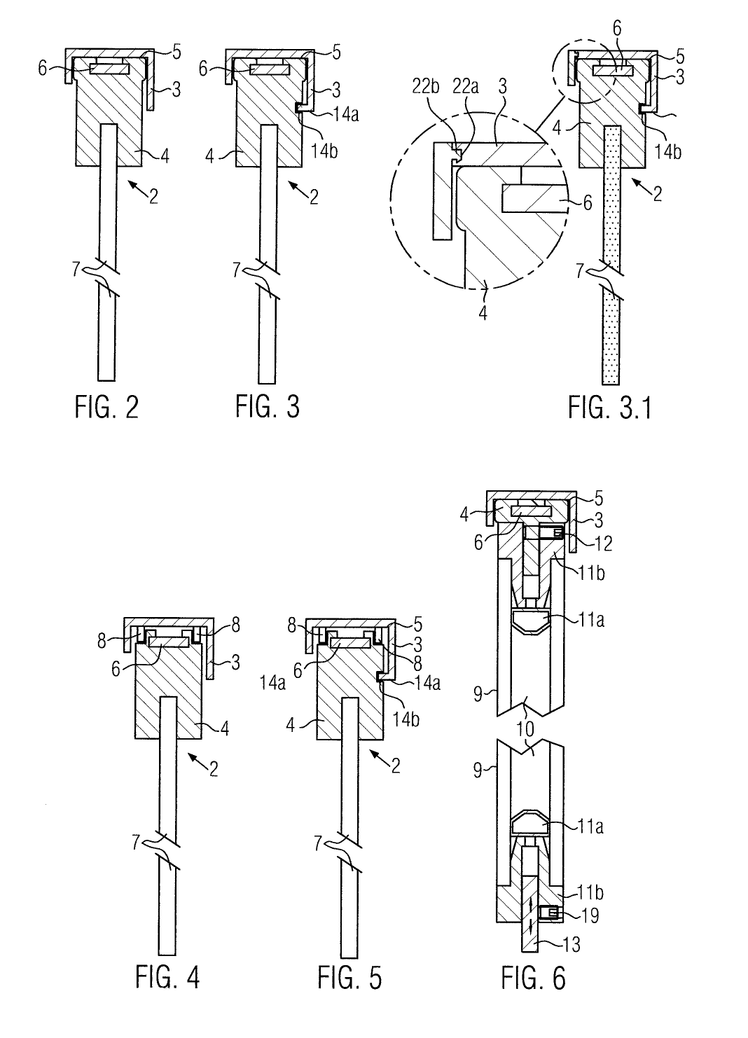

FIG. 2 schematically shows a detail of a sliding door with magnetic, support 1 according to an embodiment of the present invention, in a sectional view along a plane that is perpendicular to the sliding plane of the door leaf.

The door leaf 2 comprises a panel 7 in a single block. It can be made of glass, wood, plastic or any other material that is suitable for the final use of the sliding door 1. The single-block panel 7 is inserted in a groove made in the underside of the first coupling means 4. The panel 7 can be fixed in the groove in the first coupling means 4 through suitable fixing means, for example glue or the like.

The first coupling means 4 are mounted on the top end of the door leaf 2. At their top end, the end opposite the one to which the panel 7 is fixed, the first coupling means 4 are provided with a cavity in the shape, for example, of a T, which houses the magnetic elements 6. The magnetic elements 6, in the figure shown, are in the shape of a parallelepiped, compatible with the T-shape of the cavity in which they are housed. However, both the cavity made in the first coupling means 4 and the magnetic elements 6 can have other shapes, for example cylindrical, cubic, disc-like or similar shapes, preferably compatible with one another.

The shape of the cavity of the first coupling means 4 makes it possible to maintain a predefined distance d between the magnetic elements 6 and the second coupling means 5. In particular, according to the present invention, the cavities of the first coupling means 4 that accommodate the magnetic elements 6 are structured in such a way that the magnetic elements 6 accommodated therein are not in direct physical contact with the second coupling means 5 with which they interact magnetically. This facilitates the relative movement of the door leaf 2 with respect to the guide 3.

The magnetic elements 6 exert a magnetic force with respect to the second coupling means 5, so that the weight of the door leaf 2 is supported through this magnetic force. The second coupling means 5 comprise a material that is affected by the magnetic force generated by the magnetic elements 6, for example a metallic, ferromagnetic or paramagnetic material. The second coupling means 5, in the embodiment illustrated herein, comprise the surface of the guide 3 that is directed towards the door leaf 2. This surface can, therefore, be made of a metallic material or a ferromagnetic or paramagnetic material. Furthermore, this surface of the guide 3 can be covered with a metallic, ferromagnetic or paramagnetic material. The rest of the guide 3 can be made in any material, not necessarily a metallic material, for example wood or plastic.

In order to make the friction between the first and the second coupling means 4 and 5, which are kept in contact by the magnetic force exerted by the magnetic elements 6, as low as possible, the first coupling means 4 can be covered or be completely made with a material with a low friction coefficient, for example Teflon or self-lubricating plastics like Arnite, Vulcolon or POM. In particular, the surface of the first coupling means 4 that is in contact with the second coupling means 5 may comprise a material with a low friction coefficient.

The guide 3 is in the shape of an overturned and asymmetrical U. More particularly, asymmetrical means that the two legs of the overturned U have two different lengths.

This particular shape of the guide 3 makes it very easy to insert the door leaf 2 in its seat inside the guide 3, by moving the door leaf 2 near the guide 3, on the side corresponding to the shorter leg of the U, and letting the magnetic force exerted by the magnetic elements 6 on the second coupling means 5, in the guide 3, automatically place the door leaf 2 in its seat.

Once the door leaf 2 of the sliding door 1 has been placed in its seat, its weight is completely supported by the magnetic force exerted by the magnetic elements 6 on the second coupling means 5. The weight of the door leaf 2 is supported by the magnetic force over its entire stroke along the guide 3.

FIG. 3 shows a detail of a sliding door with magnetic support 1 according to a further embodiment of the present invention, in a sectional view along a plane that is perpendicular to the sliding plane of the door leaf.

In this case, the sliding door illustrated in the figure differs from the one shown in FIG. 2 due to the fact that the system furthermore comprises safety means intended to limit the downward movement of the door leaf 2 in order to prevent the door leaf 2 from slipping out of the guide 3, for example in the cases where the door leaf 2 is accidentally hit or pushed downwards.

In particular, the guide 3 comprises, only on the side of the overturned U that corresponds to the longer leg, a projecting element 14a that projects towards the first coupling means 4 and that can be advantageously inserted in a suitable cavity 14b made in the first coupling means 4. The fact that the projecting element 14a is provided only on the longer leg of the overturned U of the guide 3 ensures that the door leaf 2 can be easily and comfortably inserted in the guide 3 frontally. The projecting element 14a does not contribute to supporting the weight of the door leaf 2. The projecting element 14a, with the cavity 14b in which it is housed, ensures that the door leaf 2 does not slip out of its seat and move downwards, for example when the door leaf is accidentally hit or pushed downwards.

FIG. 3.1 shows a detail of a sliding door with magnetic support 1 according to a further embodiment of the present invention, in a sectional view along a plane that is perpendicular to the sliding plane of the door leaf. A part of the detail is enlarged.

In this case, the sliding door 1 differs from the one shown in FIG. 3 due to the fact that the system comprises also a snap-on cover 22. More particularly, the guide 3 comprises a first element comprising a projecting element 22b and a second element comprising a cavity 22a suited to accommodate said projecting element 22b. The first and the second element form the snap-on cover 22 that is better visible in the enlarged figure on the left. The snap-on cover 22 makes it even easier to install the sliding door 1 frontally. In particular, after removing the first element, it is possible to easily insert the sliding door 1 inside the guide 3. FIG. 4 shows a detail of a sliding door with magnetic support 1 according to a further embodiment of the present invention, in a sectional view along a plane that is perpendicular to the sliding plane of the door leaf.

In this configuration, the first coupling means 4 comprise rolling means 8, for example wheels, in such a way as to facilitate the sliding movement of the door leaf 2 along the guide 3. The first coupling means 4 comprise grooves in which the wheels 8 are housed. The second coupling means 5 may comprise rails, in which the rolling means 8 can be inserted, in such a way as to properly control the movement of the door leaf 2 with respect to the guide 3.

FIG. 4 shows a pair of wheels 8, in which each wheel is positioned on one side of a magnetic element 6. The system may comprise just one pair of wheels 8 or a plurality of pairs of wheels 8. For example, each magnetic element 6 can be associated with a pair of wheels 8. The magnetic elements 6 are housed in apposite T-shaped cavities in a way analogous to that shown in FIG. 2.

The weight of the door leaf 2 of the magnetic door 1 is entirely supported by the magnetic means 6, while the rolling means 8 do not contribute to supporting the weight of the door leaf 2, but are suited to facilitate the relative movement of the door leaf 2 with respect to the guide 3.

The guide 3 is in the shape of an overturned and asymmetrical U. More particularly, asymmetrical means that the two legs of the overturned U have two different lengths. This particular shape of the guide 3 makes it very simple to insert the door leaf 2 in its seat inside the guide 3 by moving the door leaf 2 near the guide 3, on the side corresponding to the shorter leg of the U, and letting the magnetic force exerted by the magnetic elements 6 on the second coupling means 5, in the guide 3, automatically place the door leaf 2 in its seat.

FIG. 5 shows a detail of a sliding door with magnetic support 1 according to a further embodiment of the present invention, in a sectional view along a plane that is perpendicular to the sliding plane of the door leaf.

In this case, the sliding door illustrated in the figure differs from the one shown in FIG. 4 due to the fact that the system furthermore comprises safety means intended to limit the downward movement of the door leaf 2 in order to prevent the door leaf 2 from slipping out of the guide 3.

In particular, the guide 3 comprises, only on the side of the overturned U that corresponds to the longer leg, a projecting element 14a that projects towards the first coupling means 4 and that can be advantageously inserted in a suitable cavity 14b made in the first coupling means 4. The fact that the projecting element 14a is provided only on the longer leg of the overturned U of the guide 3 ensures that the door leaf 2 can be easily and comfortably inserted in the guide 3 frontally. The projecting element 14a does not contribute to supporting the weight of the door leaf 2. The projecting element 14a, with the cavity in which it is housed, ensures that the door leaf 2 does not slip out of its seat and move downwards, for example when the door leaf is accidentally hit or pushed downwards.

The projecting element 14a, with the cavity in which it is housed, ensures that the door leaf 2 does not slip out of its seat and lower down, for example when the door leaf is accidentally hit or pushed downward.

FIG. 6 schematically shows a detail of a sliding door with magnetic support 1 according to a further embodiment of the present invention, in a sectional view along a plane that is perpendicular to the sliding plane of the door leaf.

The panel 7 of the door leaf 2 is a double-glazing panel. The panel 7 comprises two glass panes 9, separated by an empty space 10 and kept together by two spacer elements, one at each one of the two upper and lower ends of the panel 7. The empty space 10 can be filled with air or other gases, for example noble gases, in such a way as to improve the heat and/or sound insulation of the door. Each spacer element of the system comprises two parts, a polygonal element 11a with its side faces parallel to the two glass panes of the panel 7 and two L-shaped elements 11b. The elements 11b respectively house, fixed to the long section of the L, the two glass panes 9 and are fixed to the element 11a at the end of the long section of the L.

The first coupling means 4 are fixed to the spacer element located at the top end of the panel 7. In particular, the first coupling means 4 are in the shape of a T. The leg of the T is inserted between the L-shaped elements 11b of the spacer element of the top end of the panel 7. The spacer element is fixed to the first coupling means 4 through fixing means 12 that may comprise, for example, one or more screws or similar means.

The magnetic elements 6 are housed in one or more T-shaped cavities positioned in the top part of the first coupling means 4. The T-shape of the cavities makes it possible to maintain a predefined distance d between the magnetic elements 6 of the first coupling means 4 and the second coupling means 5. In particular, the cavities are structured in such a way that the magnetic elements 6 housed in them are not in direct physical contact with the second coupling means 5 with which they interact magnetically. This facilitates the relative movement of the door leaf 2 with respect to the guide 3.

The magnetic elements 6 exert an attractive magnetic force with respect to the second coupling means 5. The second coupling means 5 comprise a material that is affected by the magnetic force generated by the magnetic elements 6, for example a metallic material, a ferromagnetic material or a paramagnetic material. The second coupling means 5, in the embodiment shown, comprise the surface of the guide 3 directed towards the first coupling means 4. This surface can thus be made in a metallic material or a ferromagnetic material or a paramagnetic material. Furthermore, this surface of the guide 3 can be covered with a metallic, ferromagnetic or paramagnetic material. The rest of the guide 3 can be made in any material, not necessarily a metallic material, for example wood or plastic. In order to make the friction between the first and the second coupling means 4 and 5, kept in contact by the magnetic force exerted by the magnetic elements 6, as low as possible, the first coupling means 4 can be covered or entirely made with a material with a low friction coefficient, for example Teflon or self-lubricating plastics like Arnite, Vulcolon or POM. In particular, the surface of the first coupling means 4 in contact with the second coupling means 5 may comprise material with a low friction coefficient.

The system comprises, furthermore, safety means 13, suited to limit the downward movement of the door leaf 2 in order to prevent the latter from slipping out of the guide 3, for example when the door leaf itself is accidentally hit or pushed.

More particularly, a skirt 13 is inserted between the two L-shaped elements 11b of the spacer element mounted on the bottom end of the double-glazing panel 7. The skirt 13 comprises a long and narrow thin sheet that can slide with respect to the door leaf 2 in such a way as to project from the door leaf 2 at different heights, in order to make it possible to adjust the maximum distance between the bottom end of the door leaf 2 and the ground. In particular, the skirt 13 is slidingly housed in a slit made in the spacer element. The skirt 13 can thus be fixed at different heights inside the L-shaped elements 11b of the spacer element by means of a fixing element 19 that can conveniently by a screw or a similar element. The skirt 13 shown in the figure is in position of use, projecting from the panel 7. When the skirt 13 is extracted as much possible but so that the skirt can in any way remain fixed to the system, the distance between the bottom end of the system and the ground is minimal.

Advantageously, the skirt system can be adapted also to the single-block panel. The guide 3 is in the shape of an overturned and asymmetrical U. More particularly, asymmetrical means that the two legs of the overturned U have two different lengths.

This particular shape of the guide 3 makes it very simple to insert the door leaf 2 in its seat inside the guide 3, by moving the door leaf 2 near the guide 3, on the side corresponding to the shorter leg of the U, and letting the attractive magnetic force exerted by the magnetic elements 6 on the second coupling means 5, in the guide 3, automatically place the door leaf 2 in its seat.

Once the door leaf 2 of the sliding door 1 has been placed in its seat, its weight is completely supported by the magnetic force exerted by the magnetic elements 6 on the second coupling means 5. The weight of the door leaf 2 is supported by the attractive magnetic force over its entire stroke along the guide 3.

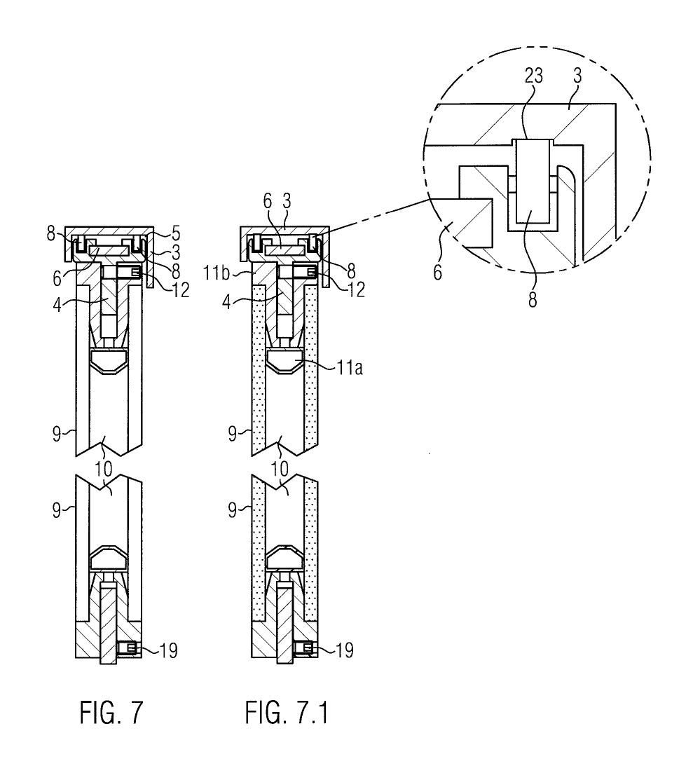

FIG. 7 schematically shows a detail of a sliding door with magnetic support 1 according to a further embodiment of the present invention, in a sectional view along a plane that is perpendicular to the sliding plane of the door leaf.

In this case, the sliding door shown in the figure differs from the one shown in FIG. 6 due to the fact that the first coupling means 4 comprise one or more rolling means 8, for example wheels, in such a way as to facilitate the sliding movement of the door leaf 2 along the guide. 3. The first coupling means 4 comprise grooves in which the wheels 8 are housed. The second coupling means 5 may comprise rails, in which the rolling means 8 can be inserted, so as to better control the movement of the door leaf 2 with respect to the guide 3. FIG. 7 shows a pair of wheels 8, in which each wheel is positioned at one side of a magnetic element 6. The system may comprise just one pair of wheels 8 or a plurality of pairs of wheels 8. For example, each magnetic element 6 can be associated with a pair of wheels 8.

The magnetic elements 6 are housed in apposite T-shaped cavities in a way analogous to that shown in FIG. 6. Also in this case, in fact, the magnetic elements 6 of the first coupling means 4 are not in direct contact with the second coupling means 5.

The weight of the door leaf 2 of the sliding door 1 is entirely supported by the magnetic elements 6, while the rolling means 8 do not contribute to supporting the weight of the door leaf 2, but are suited to facilitate the relative movement of the door leaf 2 with respect to the guide 3.

Also the system shown in FIG. 7 is provided with safety means intended to limit the downward movement of the door leaf in order to prevent the latter from slipping out of the guide, in a way analogous to that shown in FIG. 6. In particular, the skirt 13 shown in FIG. 7 is in an almost completely retracted position between the L-shaped elements 11b of the spacer element of the double-glazing panel 7.

From a comparison between FIG. 6 and FIG. 7 it can be observed that the sliding movement of the skirt 13 makes it possible to adjust the maximum distance between the bottom end of the door leaf and the ground.

FIG. 7.1 shows a detail of a sliding door with magnetic support 1 according to a further embodiment of the present invention, in a sectional view along a plane that is perpendicular to the sliding plane of the door leaf. In this case the sliding door 1 shown in the figure differs from the one shown in FIG. 7 due to the fact that the system furthermore comprises the raceways 23. More particularly, the guide 3 comprises the raceways 23 suited to house the wheels 8 during the sliding movement. The raceway 23 prevents the wheels 8 from moving in the direction that is perpendicular to the sliding plane of the door leaf 2.

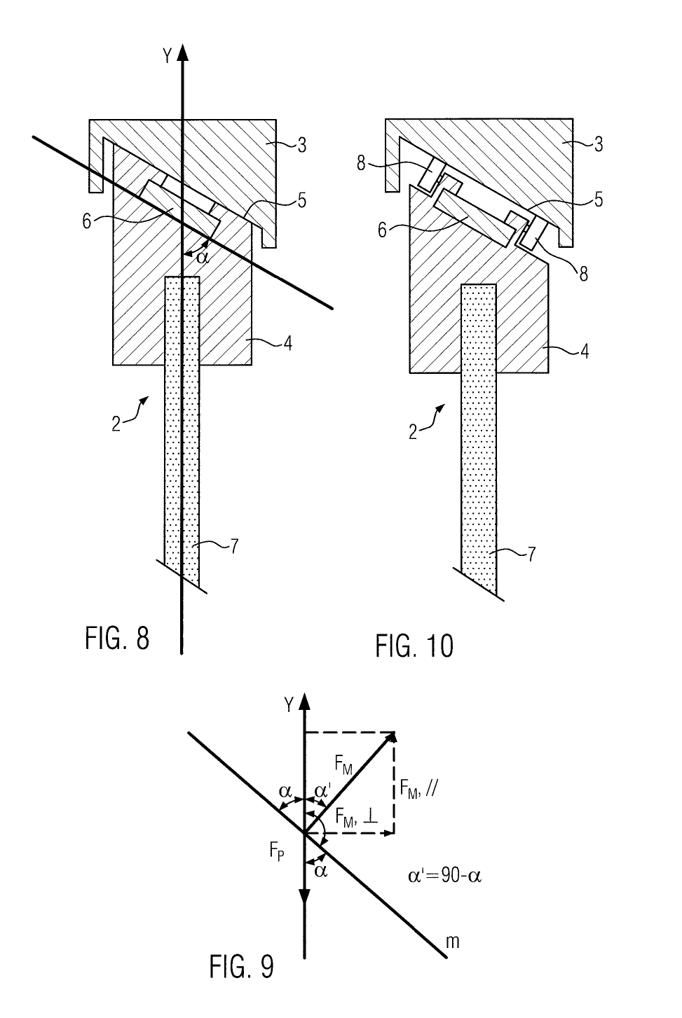

FIG. 8 shows a detail of a sliding door with magnetic support 1 according to a further embodiment of the present invention, in a sectional view along a plane that is perpendicular to the sliding plane of the door leaf.

The system illustrated is similar to that shown in FIG. 2, but in this case the magnetic force FM that supports the weight of the door leaf 2 comprises a vertical component FM,// parallel to the weight force FP of the door leaf 2 and a horizontal component FM,^{⊥} perpendicular to the vertical component FM,//. The horizontal component FM,^{⊥} is different from zero, in such a way as to stabilize the door leaf 2 during the sliding movement along the guide 3. In particular, the first coupling means 4 and the second coupling means 5 are configured in such a way that the magnetic force FM has a horizontal component FM,^{⊥} that is not equal to zero.

In the example shown in FIG. 8, the plane that contains the surface of the first coupling means 4 facing towards the guide 3 forms an angle α different from 90° with respect to the plane Y of the door leaf 2.

The surface of the second coupling means 5 facing towards the first coupling means 4 is parallel to the top surface of the first coupling means 4 and is in contact with it. Also the surface of the second coupling means 5 facing towards the first coupling means 4 thus forms an angle α with respect to the plane Y of the door leaf 2. The magnetic element 6 is housed in a T-shaped cavity created in the upper surface of the first coupling means 4. The cavity is made in such a way that the magnetic element 6 is parallel to the upper surface of the coupling means 4. At the same time, the magnetic element 6 is not in physical contact with the second coupling means 5. In this configuration, the magnetic force FM comprises a vertical component FM,//, parallel to the weight force FP of the door leaf 2, and a horizontal component FM,^{⊥}, perpendicular to the vertical component FM,//, wherein the horizontal component is different from zero, so as to stabilize the door leaf 2 during its sliding movement along the guide 3.

In particular, as can be observed in detail in FIG. 9, the component of the magnetic force exerted by the magnetic elements 6 on the second coupling means 5 that is parallel to the plane Y of the door leaf 2 supports the weight of the door leaf 2 and is equal to F//,M=FM cos (90−α)=FM sen α. The component of the magnetic force perpendicular to the weight force is given by F^{⊥},M=FM sen (90−α)=FM cos α. The latter component of the magnetic force pushes the door leaf 2 towards the second coupling means 5 parallel to the ground and thus ensures greater stability of the door leaf during its sliding movement along the guide 3. The panel 7 shown in the figure is of the single-block type, but alternatively it can also be of the type with double glazing.

The external perimeter of the guide 3 has the shape of an overturned and asymmetrical U. More particularly, asymmetrical means that the two legs of the overturned U have two different lengths.

This particular shape of the guide 3 makes it very easy to insert the door leaf 2 in its seat inside the guide 3, by moving the door leaf 2 near the guide 3, on the side corresponding to the shorter leg of the U, and letting the magnetic force exerted by the magnetic elements 6 on the second coupling means 5, in the guide 3, automatically place the door leaf 2 in its seat. Advantageously, the angle α is such that the assembly and installation of the door are further facilitated.

Once the door leaf 2 of the sliding door 1 has been placed in its seat, its weight is completely supported by the magnetic force exerted by the magnetic elements 6 on the second coupling means 5. The weight of the door leaf 2 is supported by the magnetic force over its entire stroke along the guide 3.

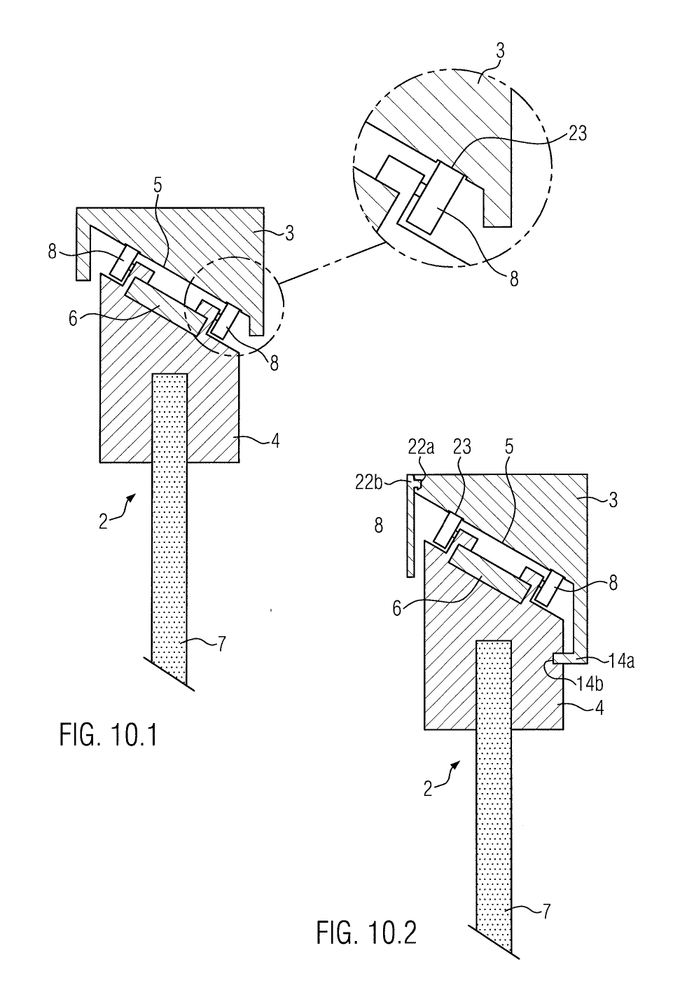

FIG. 10 shows a detail of a sliding door with magnetic support according to a further embodiment of the present invention, in a sectional view along a plane that is perpendicular to the sliding plane of the door leaf.

The door shown in the figure differs from the one shown in FIG. 8 due to the fact that the first coupling means 4 comprise one or more rolling means 8, for example wheels, in such a way as to facilitate the sliding movement of the door leaf 2 along the guide 3. The first coupling means 4 comprise grooves in which the wheels 8 are housed. The second coupling means 5 may comprise rails, in which the rolling means 8 can be inserted, in such a way as to properly control the movement of the door leaf 2 with respect to the guide 3. FIG. 10 shows a pair of wheels 8 in which each wheel is positioned at one side of a magnetic element 6. The system may comprise just one pair of wheels 8 or a plurality of pairs of wheels 8. For example, each magnetic element 6 can be associated with a pair of wheels 8. The magnetic elements 6 are housed in apposite cavities in a way that is analogous to that shown in FIG. 8.

The weight of the door leaf 2 of the sliding door 1 is completely supported by the magnetic elements 6, while the rolling means 8 do not contribute to supporting the weight of the door leaf 2, but are suited to facilitate the relative movement of the door leaf 2 with respect to the guide 3.

Also in this case, the magnetic force FM comprises a vertical component FM,//, parallel to the weight force FP of the door leaf 2, and a horizontal component FM,^{⊥}, perpendicular to the vertical component FM,//, wherein the horizontal component is different from zero, in such a way as to stabilize the door leaf 2 during its sliding movement along the guide 3.

FIG. 10.1 shows a detail of a sliding door with magnetic support 1 according to a further embodiment of the present invention, in a sectional view along a plane that is perpendicular to the sliding plane of the door leaf. A part of the detail is enlarged.

In this case the sliding door shown in the figure differs from the one shown in FIG. 10 due to the fact that the system furthermore comprises the raceways 23.

In particular, the guide 3 comprises the raceways 23 suited to house the wheels 8 during the sliding movement. The raceways 23 further ensure that the wheels 8 do not move in the direction perpendicular to the sliding plane of the door leaf 2. FIG. 10.2 shows a detail of a sliding door with magnetic support 1 according to a further embodiment of the present invention, in a sectional view along a plane that is perpendicular to the sliding plane of the door leaf. In this case the sliding door 1 shown in the figure differs from the one shown in FIG. 10.1 due to the fact that the system furthermore comprises a snap-on cover 22 and safety means suited to limit the downward movement of the door leaf 2 in order to prevent the door leaf 2 from slipping out of the guide 3, for example in the cases where the door leaf 2 is accidentally hit or pushed downwards.

In particular, the guide 3 comprises a first element comprising a projecting element 22b and a second element comprising a cavity 22a suited to house said projecting element 22b. The first and the second element form the snap-on cover 22, which allows the sliding door 1 to be installed frontally in a manner that is further facilitated.

Moreover, the guide 3 comprises, only on the side of the overturned U that corresponds to the longer leg, a projecting element 14a that projects towards the first coupling means 4 and that can be advantageously inserted in a suitable cavity 14b created in the first coupling means 4. The fact that the projecting element 14b is present only on the longer leg of the overturned U of the guide 3 ensures that the door leaf 2 can be inserted frontally in the guide 3 in a comfortable and easy way. The projecting element 14a does not contribute to supporting the weight of the door leaf 2. The projecting element 14a, with the cavity 14b in which it is housed, ensures that the door leaf 2 does not slip out of its seat and move downwards, for example when the door leaf is accidentally hit or pushed downwards.

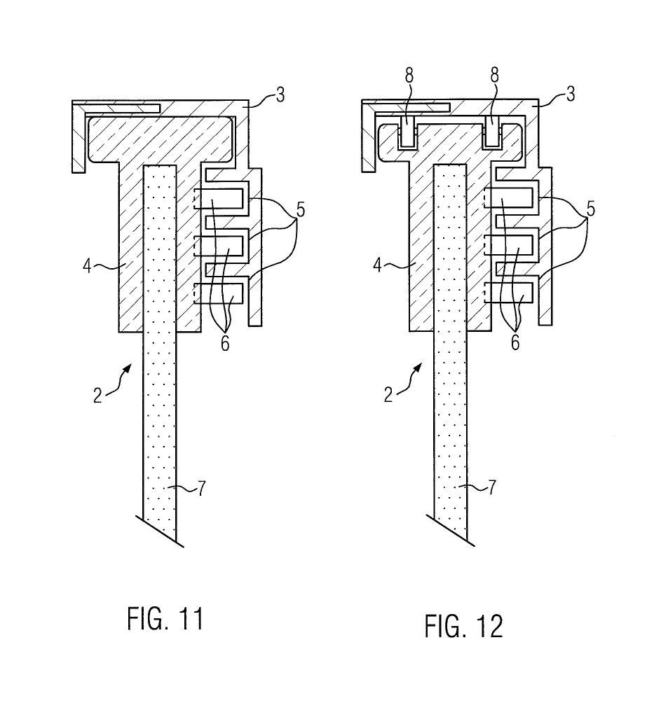

FIG. 11 schematically shows a detail of a sliding door with magnetic support 1 according to a further embodiment of the present invention, in a sectional view along a plane that is perpendicular to the sliding plane of the door leaf.

In this case the magnetic elements 6 of the first coupling means 4 are inserted in a side wall of the first coupling means 4, that is, in a wall of the first coupling means that is substantially parallel to the plane of the door leaf. The magnetic elements 6 are arranged in a comb-like pattern.

The first coupling means 4 are in the shape of a T, with suitable cavities in one of the sides, in which the magnetic elements 6 are at least partially housed. In this configuration, the magnetic elements 6 are not completely inserted in the first coupling means 4, but project from them laterally. The figure shows three overlapping rows of magnetic elements 6, but this number can appropriately vary. The system may comprise, for example, a single row of magnetic elements 6 that project laterally from the first coupling means 4. Furthermore, the system may comprise two or more overlapping rows of magnets 6. The system preferably comprises at least three rows of overlapping magnets. The upper surface of the first coupling means 4 is in direct contact with the guide 3. This guarantees that the magnetic elements 6 are at a fixed distance from the guide 3 and from the second coupling means 5. In this way, the magnetic elements 6 are not in direct contact with the second coupling means 5 with which they interact. In this configuration, the second coupling means 5 are positioned in a side inner wall of the guide 3 that faces towards the magnetic elements 6 of the first coupling means. The second coupling means 5 are made in such a way as to form grooves or slits that house the magnetic elements 6 during the sliding movement of the door leaf 2, so that the magnetic elements 6 that project laterally from the first coupling means 4 are at a suitable distance from all the sides of the grooves of the second coupling means 5 that house them during the sliding movement. The panel 7 shown in the figure is of the single-block type, but alternatively it can also be of the type with double glazing.

Advantageously, the coupling means 4 can be made in a material with a low friction coefficient, for example Teflon or self-lubricating plastics like Arnite, Vulcolon or POM, in such a way as to facilitate the relative movement of the door leaf 2 with respect to the guide 3. In particular, the surface of the first coupling means 4 in contact with the guide may comprise material a with low friction coefficient. In the system shown in FIG. 11 also the surface of the guide 3 in contact with the first coupling means 4 can be made from material with a low friction coefficient.

The external perimeter of the guide 3 has the shape of an overturned and asymmetrical U. More particularly, asymmetrical means that the two legs of the overturned U have two different lengths. In this embodiment of the invention, the longer leg of the U has a step.

This particular shape of the guide 3 makes it very easy to insert the door leaf 2 in its seat inside the guide 3, by moving the door leaf 2 near the guide 3, on the side corresponding to the shorter leg of the U, and letting the magnetic force exerted by the magnetic elements 6 on the second coupling means 5, in the guide 3, automatically place the door leaf 2 in its seat. Advantageously, this configuration is such as to make the assembly operation simple and at the same time guarantee high stability of the door leaf 2 during its sliding movement along the guide 3. The lateral position of the magnetic elements 6, in fact, prevents the door leaf 2 from easily falling downwards as it moves from its seat due, for example, to impacts against the door leaf itself. In this configuration, therefore, the magnetic elements 6 and the guide 3 comprising the second coupling means 5 also serve as safety means.

Once the door leaf 2 of the sliding door 1 has been placed in its seat, its weight is completely supported by the magnetic force exerted by the magnetic elements 6 on the second coupling means 5. The weight of the door leaf 2 is supported by the magnetic force over its entire stroke along the guide 3.

FIG. 12 schematically shows a detail of a sliding door with magnetic support 1 according to a further embodiment of the present invention, in a sectional view along a plane that is perpendicular to the sliding plane of the door leaf.

The sliding door illustrated in the figure differs from the one shown in FIG. 11 due to the fact that the first coupling means 4 comprise one or more rolling means 8, for example wheels, in such a way as to facilitate the sliding movement of the door leaf 2 along the guide 3. The first coupling means 4 comprise grooves in which the wheels 8 are housed. The second coupling means 5 may comprise rails, in which the rolling means 8 can be inserted, in such a way as to properly control the movement of the door leaf 2 with respect to the guide 3. The system can alternatively be provided with a single wheel or with one or more pairs of wheels.

The weight of the door leaf 2 of the magnetic door 1 is completely supported by the magnetic means 6, while the rolling means 8 do not contribute to supporting the weight of the door leaf 2, but are suited to facilitate the relative movement of the door leaf 2 with respect to the guide 3.

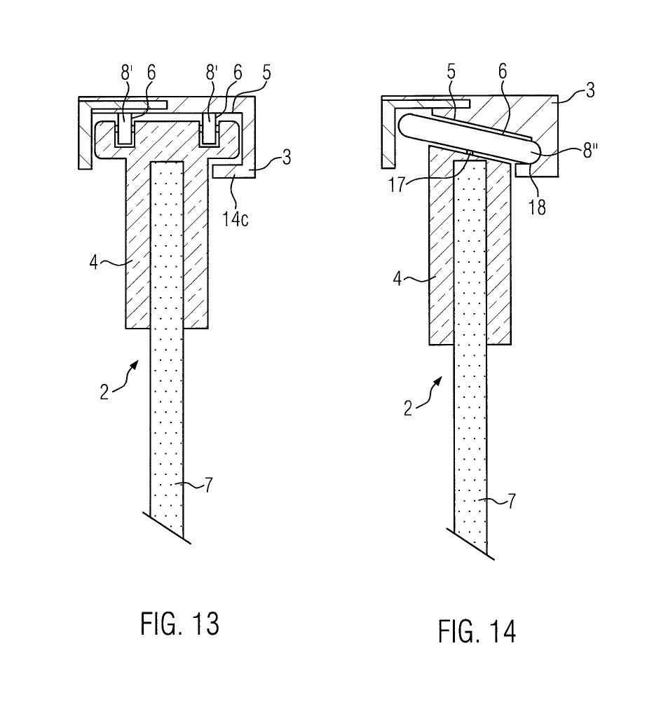

FIG. 13 schematically shows a detail of a sliding door with magnetic support 1 according to a further embodiment of the present invention, in a sectional view along a plane that is perpendicular to the sliding plane of the door leaf.

The panel 7 shown in the figure is of the single-block type, but alternatively it can also be of the double-glazing type.

The first coupling means 4 comprise one or more rolling means 8′, for example wheels, in such a way as to facilitate the sliding movement of the door leaf 2 along the guide 3. The first coupling means 4 comprise grooves in which the rolling means 8′ are housed. The second coupling means 5 may comprise rails, in which the rolling means 8′ can be inserted, in such a way as to properly control the movement of the door leaf 2 with respect to the guide 3.

In this embodiment of the invention, the rolling means 8′ comprise the magnetic elements 6. The wheels 8′ can, for example, be cylindrical magnets. Alternatively, the surface of the rolling means 8′ in contact with the second coupling means can be covered with a magnetic material.

The second coupling means 5 are constituted by the surface of the guide 3 facing towards the door leaf 2.

The guide 3 comprises, only on one side of the guide 3, a projecting safety element 14c that becomes engaged with the first coupling means 4, in such a way as to ensure that the door leaf does not slip out of its seat and move downwards, for example due to accidental impacts against the door leaf 2 itself. The projecting element 14c does not contribute to supporting the weight of the door leaf 2.

The guide 3 is in the shape of an overturned U.

This particular shape of the guide 3 makes it very easy to insert the door leaf 2 in its seat inside the guide 3, by moving the door leaf 2 near the guide 3 and letting the magnetic force exerted by the magnetic elements 6 on the second coupling means 5, in the guide 3, automatically place the door leaf 2 in its seat.

Once the door leaf 2 of the magnetic door 1 has been placed in its seat, its weight is completely supported by the magnetic means 6 included in the rolling means 8′, which however do not contribute to supporting the weight of the door leaf 2, but are suited to facilitate the relative movement of the door leaf 2 with respect to the guide 3.

According to a further preferred embodiment of the invention, the insertion of the door leaf 2 in its seat inside the guide 3 is performed in a very simple manner by moving the door leaf 2 near the guide 3 and letting the magnetic force exerted by the magnetic elements 6 on the second coupling means 5, in the guide 3, place the door leaf 2 automatically in its seat.

FIG. 14 schematically shows a detail of a sliding door with magnetic support 1 according to a further embodiment of the present invention, in a sectional view along a plane that is perpendicular to the sliding plane of the door leaf.

The first coupling means 4 comprise rolling means 8″ that comprise the magnetic elements 6. The rolling means 8″ comprise a wheel that is supported through a pin 17 by the first coupling means 4. The face of the wheel 8″ facing towards the second coupling means 5 is magnetic. In particular, the face of the wheel 8″ facing towards the second coupling means 5 may comprise one or more magnetic elements 6 or be covered with a magnetic material. The weight of the door leaf 2 of the magnetic door 1 is entirely supported by the magnetic means 6 included in the rolling means 8″ which, however, do not contribute to supporting the weight of the door leaf 2, but are suited to facilitate the relative movement of the door leaf 2 with respect to the guide 3.

The second coupling means 5 are positioned on the surface of the guide 3 facing towards the door leaf 2. The wheel 8″ slides in a recess 18 made in the guide 3. The recess 18 is made in such a way that the magnetic face 6 of the wheel 8″ is not in direct contact with the second coupling means 5.

In the configuration shown in FIG. 14, the magnetic face of the wheel 8″ forms an angle α different from 90° with respect to the plane Y of the door leaf 2. The surface of the second coupling means 5 directed towards the wheel 8 and thus interacting magnetically with the wheel 8″ is parallel to the plane of the magnetic face of the wheel 8.

In this configuration, the magnetic force FM comprises a vertical component FM,//, parallel to the weight force FP of the door leaf 2, and a horizontal component FM,^{⊥}, perpendicular to the vertical component FM,//, wherein the horizontal component is different from zero, in such a way as to stabilize the door leaf 2 during its sliding movement along the guide 3.

According to an alternative embodiment of the invention not shown in the figure, the magnetic face of the wheel 8″ is parallel to the ground. In this case the magnetic force FM has a horizontal component FM,^{⊥} that is equal to zero.

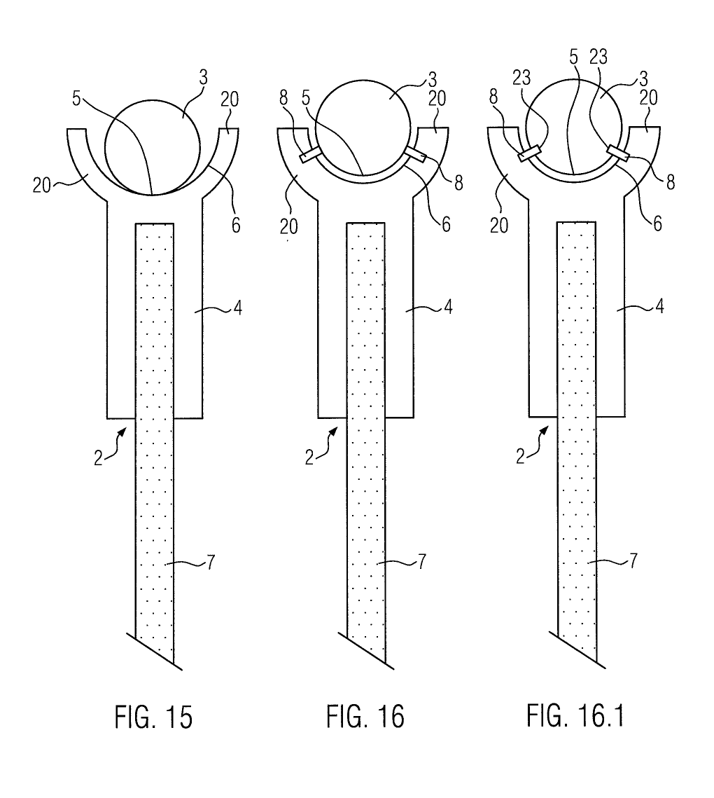

FIG. 15 schematically shows a detail of a sliding door with magnetic support 1 according to a further embodiment of the present invention, in a sectional view along a plane that is perpendicular to the sliding plane of the door leaf 2.

In this case, the first coupling means 4 are in the shape of a parallelepiped. They furthermore comprise two arms 20 projecting from their upper part and forming a hollow in the shape of a semicircle. The wall of these two arms 20 directed towards the guide 3 comprises the magnetic elements 6. More particularly, the wall of the two arms 20 directed towards the guide 3 can be at least partially covered with a layer of magnetic material.

According to this embodiment of the invention, the guide 3 is cylindrical in shape. The second coupling means 5 comprise the external wall of the guide 3 directed towards the door leaf 2 of the sliding door 1. More particularly, the second coupling means 5 may comprise a layer of a magnetic material whose polarity is opposite with respect to the polarity of the magnetic elements 6 and which covers the external wall of the guide 3 directed towards the door leaf 2.

In this configuration, the magnetic elements 6 and the second coupling means 5 are in direct physical contact. Thus, in order to limit the friction force between them, one or both of them can be covered with a layer of material with a low friction coefficient, for example Teflon.

The panel 7 shown in the figure is of the single-block type, but it can alternatively be of the type with double-glazing.

The insertion of the door leaf 2 in its seat around the guide 3 is carried out in a very simple manner, by moving the door leaf 2 near the guide 3 and letting the magnetic force exerted by the magnetic elements 6 on the second coupling means 5, in the guide 3, automatically place the door leaf 2 in its seat. Advantageously, this configuration is such that it makes the assembly operation easy.

Once the door leaf 2 of the sliding door 1 has been placed in its seat, its weight is completely supported by the magnetic force exerted by the magnetic elements 6 on the second coupling means 5. The weight of the door leaf 2 is supported by the magnetic force over its entire stroke along the guide 3.

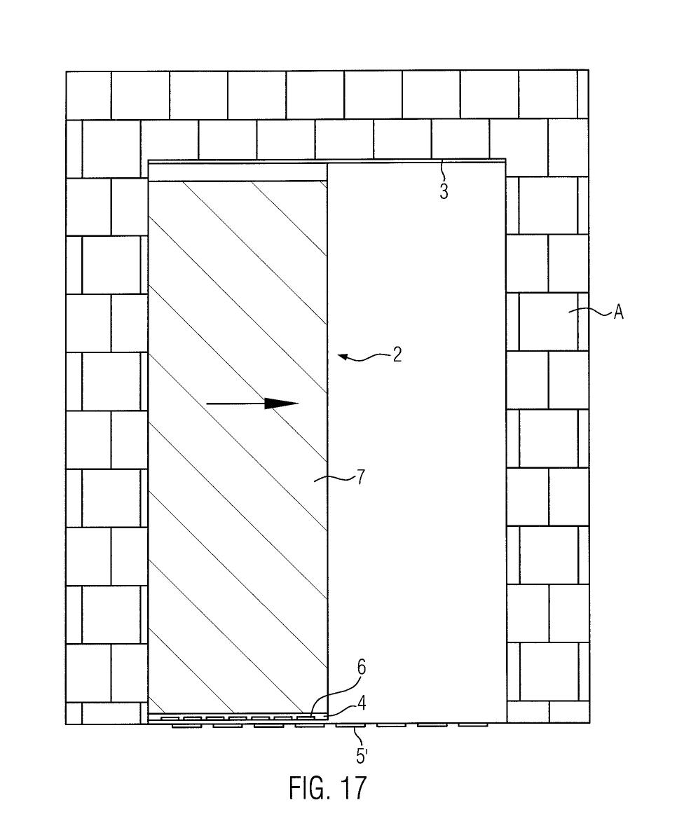

FIG. 16 schematically shows a detail of a sliding door with magnetic support 1 according to another embodiment of the present invention, in a sectional view along a plane that is perpendicular to the sliding plane of the door leaf 2.

The sliding door illustrated in the figure differs from the one shown in FIG. 15 due to the fact that the first coupling means 4 comprise one or more rolling means 8, for example wheels, in such a way as to facilitate the sliding movement of the door leaf 2 along the guide 3. The first coupling means 4 comprise grooves in which the wheels 8 that rest on the guide 3 are housed. The second coupling means 5 may comprise rails, in which the rolling means 8 can be inserted, in such a way as to properly control the movement of the door leaf 2 with respect to the guide 3. The system can alternatively be provided with a single pair of wheels or with several pairs of wheels. The weight of the door leaf 2 of the magnetic door 1 is completely supported by the magnetic means 6, while the rolling means 8 do not contribute to supporting the weight of the door leaf 2, but are suited to facilitate the relative movement of the door leaf 2 with respect to the guide 3.

FIG. 16.1 schematically shows a detail of a sliding door with magnetic support 1 according to a further embodiment of the present invention, in a sectional view along a plane that is perpendicular to the sliding plane of the door leaf 2.

In this case, the sliding door 1 shown in the figure differs from the one shown in FIG. 16 due to the fact that the system furthermore comprises a raceway 23. In particular, the guide 3 comprises the raceways 23 suited to house the wheels 8 during the sliding movement. The raceways 23 further ensure that the wheels 8 do not move in the direction that is perpendicular to the sliding plane of the door leaf 2.

FIG. 17 schematically shows a sliding door with magnetic support 1 according to a further embodiment of the present invention, in a front view.

In this case, the magnetic force that supports the weight of the door leaf 2 of the door 1 is of the repulsive type, so that the weight of the door leaf 2 is supported through magnetic levitation.

The first coupling means 4 are fixed to the bottom end of the door leaf 2 directed towards the ground. The first coupling means 4 comprise one or more magnetic elements 6. In the case shown in FIG. 17, the system comprises a plurality of magnetic elements 6 arranged consistently, meaning in such a way that they all have the same pole, for example the positive pole, directed towards the ground. The opposite pole, for example the negative one, is thus directed towards the door leaf 2.

The second coupling means 5′ are fixed in such a way that they are directed towards the magnetic elements 6 of the first coupling means 4. For example, the second coupling means 5′ can be fixed to the lower part of the supporting element A on which the door is mounted. If the door comprises, for example, a frame that surrounds it on four sides, the second coupling means 5′ can be fixed to the lower side of the frame, meaning the side along which the door leaf 2 slides. In the example shown in FIG. 17 the second coupling means 5′ are fixed to the ground.

The second coupling means 5′ comprise a plurality of magnetic elements arranged, with respect to the magnetic elements 6 of the first coupling means 4, in such a way that the magnetic force between the first and the second coupling means is of the repulsive type. For example, the magnetic elements can be arranged in such a way that they all have the same pole directed towards the ground. In this way, the two rows of magnetic elements 6 and are arranged in such a way as to repel each other. The weight of the door leaf 2 is thus supported through magnetic levitation over the entire stroke of the door leaf 2 along the guide 3.

The door comprises the guide 3 that allows the door leaf 2 to slide along the guide 3. The guide 3 is positioned on the top side of the door 1. The repulsive magnetic interaction between the first coupling means 4 and the second coupling means 5′ makes it possible to couple the door leaf 2 with the guide 3. In particular, since the weight of the door leaf 2 is supported through magnetic levitation owing to the repulsive force that is exerted between the first and the second coupling means 4 and 5′, the door leaf 2 is kept in position along the guide 3.

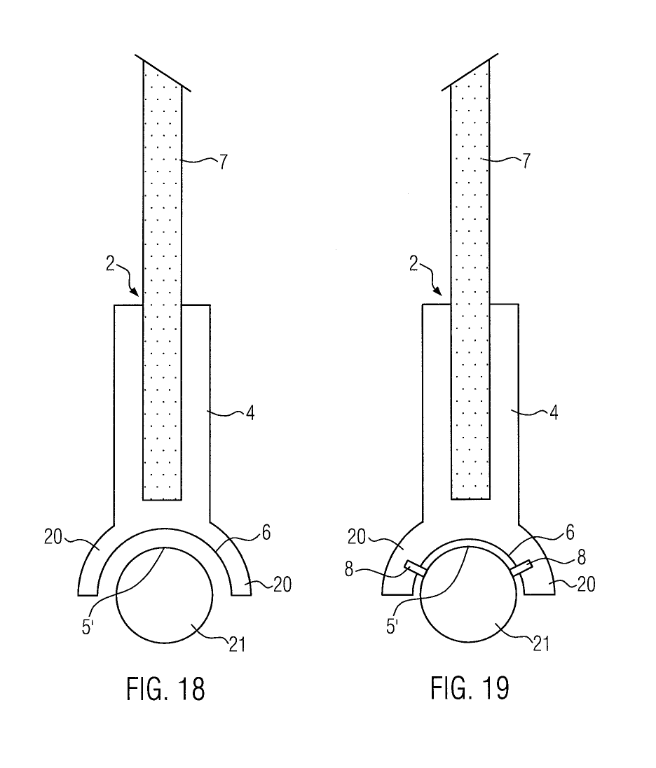

FIG. 18 schematically shows a detail of a sliding door with magnetic support 1 according to another embodiment of the present invention in which the weight of the door leaf is supported by magnetic levitation, in a sectional view along a plane that is perpendicular to the sliding plane of the door leaf 2.

In this case, the magnetic force that supports the weight of the door leaf 2 of the door 1 is of the repulsive type, so that the weight of the door leaf 2 is supported through magnetic levitation.

The first coupling means 4 are fixed to the bottom end of the door leaf 2 directed towards the ground. In this case, the first coupling means 4 are in the shape of a parallelepiped. They furthermore comprise two arms 20 projecting from their lower part and forming a hollow in the shape of a semicircle. The wall of these two arms 20 directed towards the ground comprises the magnetic elements 6. More particularly, the wall of the two arms 20 directed towards the ground can be at least partially covered with a layer of magnetic material.

The second coupling means 5′ comprise the external portion of a cylindrical element 21 that is directed towards the magnetic elements 6. More particularly, the second coupling means 5′ may comprise a layer of a magnetic material whose polarity is equal to the polarity of the magnetic elements 6 and which covers the external wall of the cylindrical element 21 facing towards the door leaf 2. The cylindrical element 21 comprising the second coupling means 5′ can be fixed to the lower part of the supporting element A on which the door is mounted. If the door comprises, for example, a frame that surrounds it on four sides, the cylindrical element 21 can be fixed to the lower side of the frame, meaning the side along which the door leaf 2 slides.

In this configuration, the magnetic force between the first and the second coupling means 5′ and 6 is of the repulsive type. The weight of the door leaf 2 is thus supported through magnetic levitation over the entire stroke of the door leaf 2 along the guide 3.

The sliding door 1 comprises, furthermore, the guide 3 that allows the door leaf 2 to slide along the guide 3. The guide 3 is positioned on the top side of the sliding door 1. The repulsive magnetic interaction between the first coupling means 4 and the second coupling means 5′ makes it possible to couple the door leaf 2 with the guide 3. In particular, since the weight of the door leaf 2 is supported through magnetic levitation owing to the repulsive force that is exerted between the first and the second coupling means 4 and 5′, the door leaf 2 is kept in position along the guide 3.

FIG. 19 schematically shows a detail of a sliding door with magnetic support 1 according to another embodiment of the present invention in which the weight of the door leaf is supported through magnetic levitation, in a sectional view along a plane that is perpendicular to the sliding plane of the door leaf 2.

The sliding door illustrated in the figure differs from the one shown in FIG. 18 due to the fact that the first coupling means 4 comprise one or more rolling means 8, for example wheels. The first coupling means 4 comprise grooves in which the wheels 8 that rest on the cylindrical elements 21 are housed. Alternatively, the system can be provided with a single pair of wheels or with several pairs of wheels.

The weight of the door leaf 2 of the magnetic door 1 is completely supported by the magnetic means 6, while the rolling means 8 do not contribute to supporting the weight of the door leaf 2, but are suited to facilitate the relative movement of the door leaf 2 with respect to the guide 3.

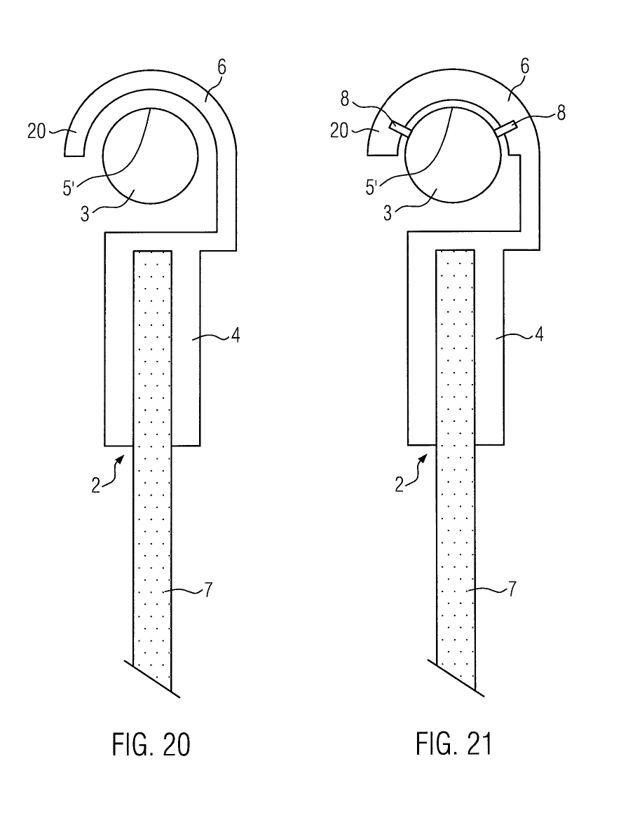

FIG. 20 schematically shows a detail of a sliding door with magnetic support 1 according to another embodiment of the present invention in which the weight of the door leaf is supported through magnetic levitation, in a sectional view along a plane that is perpendicular to the sliding plane of the door leaf.

In this case, the magnetic force that supports the weight of the door leaf 2 of the door 1 is of the repulsive type, so that the weight of the door leaf 2 is supported through magnetic levitation.

In this case, the first coupling means 4 are in the shape of a parallelepiped. They furthermore comprise a hook-shaped arm 20 projecting from the upper part of the first coupling means 4. The wall of this arm 20 facing towards the guide 3 comprises the magnetic elements 6. More particularly, the wall of the arm 20 can be at least partially covered with a layer of magnetic material.

According to this embodiment of the invention, the guide 3 is cylindrical in shape. It is inserted in the arm 20 of the first coupling means 4. The second coupling means 5 comprise the external wall of the guide 3 facing towards the arm 20 of the first coupling means 4. More particularly, the second coupling means 5 may comprise a layer of a magnetic material whose polarity is equal to the polarity of the magnetic elements 6 and which covers the part of the guide 3 that is directed towards the arm 20 of the first coupling means 4.

In this configuration, the magnetic force between the magnetic elements 6 and the second coupling means 5 is of the repulsive type. In this way the magnetic elements 6 and the second coupling means 5 are arranged so that they repel each other. The weight of the door leaf 2 is thus supported through magnetic levitation over the entire stroke of the door leaf 2 along the guide 3.

The panel 7 shown in the figure is of the single-block type, but alternatively it can also be of the type with double glazing.

FIG. 21 schematically shows a detail of a sliding door with magnetic support 1 according to another embodiment of the present invention in which the weight of the door leaf is supported through magnetic levitation, in a sectional view along a plane that is perpendicular to the sliding plane of the door leaf.

The sliding door illustrated in the figure differs from the one shown in FIG. 20 due to the fact that the first coupling means 4 comprise one or more rolling means 8, for example wheels, in such a way as to facilitate the sliding movement of the door leaf 2 along the guide 3. The first coupling means 4 comprise grooves in which the wheels 8 that rest on the guide 3 are housed. Alternatively, the system can be provided with a single pair of wheels or with several pairs of wheels.

The weight of the door leaf 2 of the magnetic door 1 is completely supported by the magnetic means 6, while the rolling means 8 do not contribute to supporting the weight of the door leaf 2, but are suited to facilitate the relative movement of the door leaf 2 with respect to the guide 3.

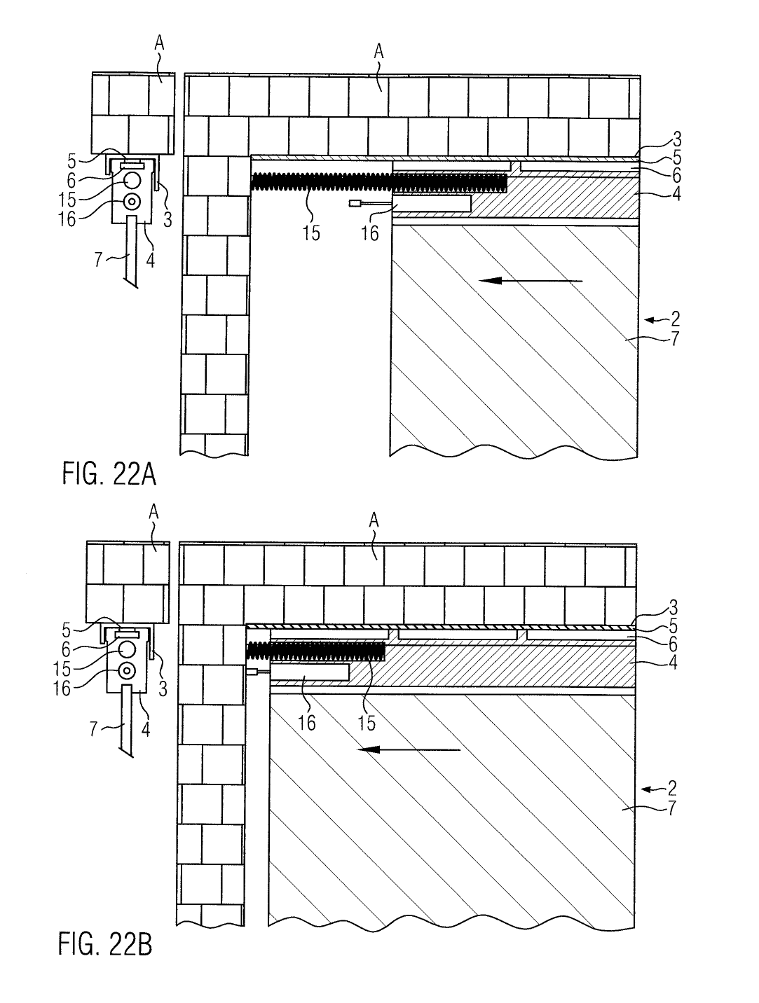

FIG. 22A schematically shows a detail of a sliding door with magnetic support 1 according to a further embodiment of the present invention, in a sectional view along a plane that is perpendicular to the sliding plane of the door leaf (left) and in a front view (right). The door is shown in a half-open position.

The door leaf 2 of the sliding door 1 shown in the figure comprises elastic elements 15 suited to automatize the operation required to open and/or close the door 1.

In the case illustrated herein the elastic element 15 is a spring. The sliding door 1 is half-open and the spring 15 is in a semi-rest condition. Once the door opening operation has been started, the spring 15 properly pushes the door leaf 2 and thus ensures that the latter opens completely in an automatic manner. The spring 15 can also be mounted in such a way as to ensure that the door 1 closes automatically.

The door shown in FIG. 22A furthermore comprises shock-absorbing elements 16 suited to properly slow down the sliding movement of the door leaf 2 along the guide 3 during the opening and/or closing of the door 1.

In the case illustrated above the shock-absorbing element 16 is a piston. It prevents the door from slamming abruptly against the support A by slowing down the movement of the door leaf 2 while it is closing. The piston 16 can also be mounted in such a way as to slow down the movement of the door leaf 2 while it is opening.

FIG. 22B schematically shows a detail of a sliding door with magnetic support 1, like the one shown in FIG. 22A, in a sectional view along a plane that is perpendicular to the sliding plane of the door leaf.

In this case the door is in the closed position, with the spring 15 stretched.

In the examples shown in FIGS. 22A and 22B, the structure of the first coupling means 4 and of the second coupling means 5 is analogous to that shown in FIG. 5. In particular, as can be observed in the sectional views of FIGS. 22A and 22B, the first coupling means 4 differ from those shown in FIG. 5 due to the fact that they furthermore comprise housings suited to advantageously accommodate the elastic means 15 and the shock-absorbing elements 16.

However, both the elastic elements 15 and the shock-absorbing elements 16 can be present on any one of the embodiments described above and schematically illustrated in Figures from 2 to 21. Furthermore, the panel 7 shown in FIGS. 22A and 22B is of the single-block type, but alternatively it can also be of the type with double glazing.

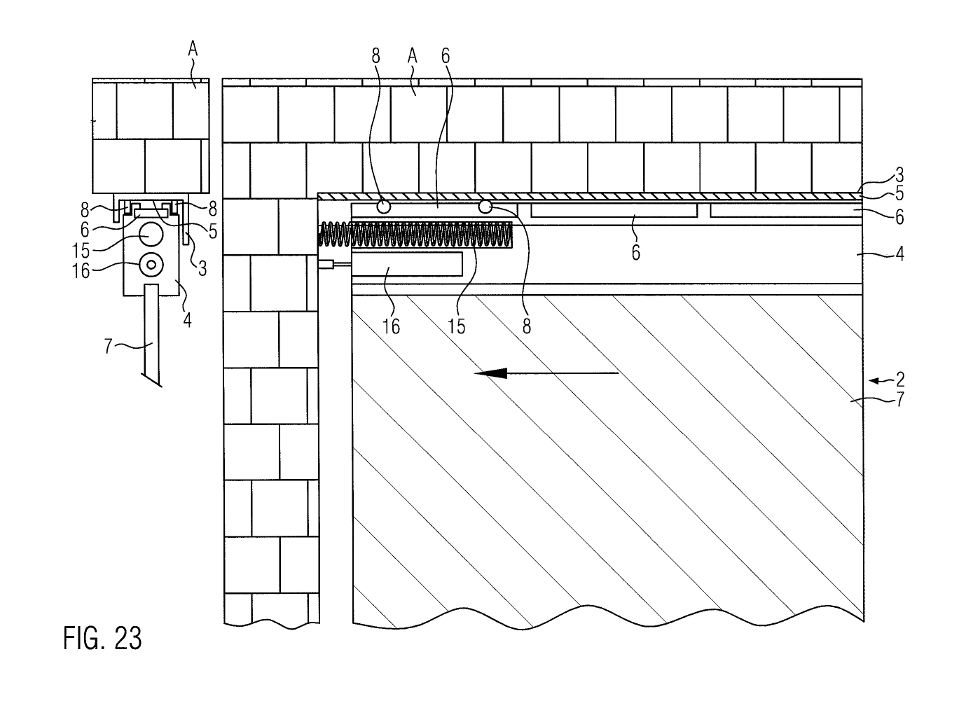

FIG. 23 schematically shows a detail of a sliding door with magnetic support 1 according to a further embodiment of the present invention, in a sectional view along a plane that is perpendicular to the sliding plane of the door leaf (left) and in a front view (right).

The door is shown in the closed position, the spring 15 is stretched.

In this case, the sliding door shown in the figure differs from the one shown in FIGS. 22A and 22B due to the fact that the first coupling means 4 comprise one or more rolling means 8, for example wheels, in such a way as to facilitate the sliding movement of the door leaf 2 along the guide 3. The second coupling means 5 may comprise rails, in which the rolling means 8 can be inserted, in such a way as to properly control the movement of the door leaf 2 with respect to the guide 3. The first coupling means 4 may comprise grooves in which the wheels 8 are housed. In the example shown in FIG. 23, two pairs of wheels 8 are associated with only one of the magnetic elements 6 of the first coupling means 4. The other magnetic elements 6 of the system are not associated with wheels. The panel 7 shown in FIG. 23 is of the single-block type, but alternatively it can also be of the type with double glazing.

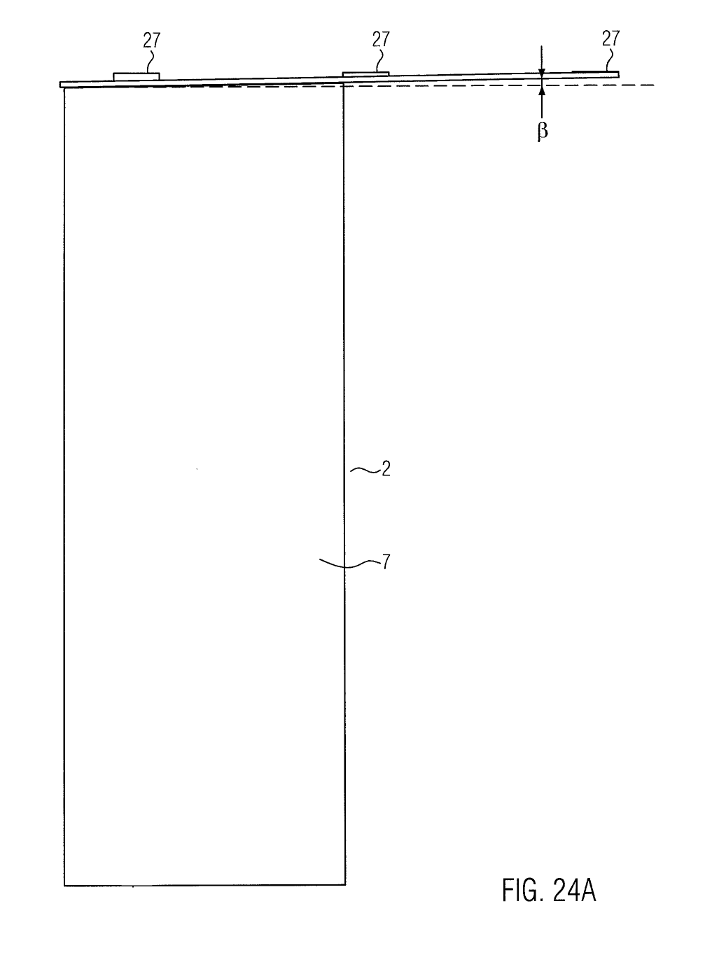

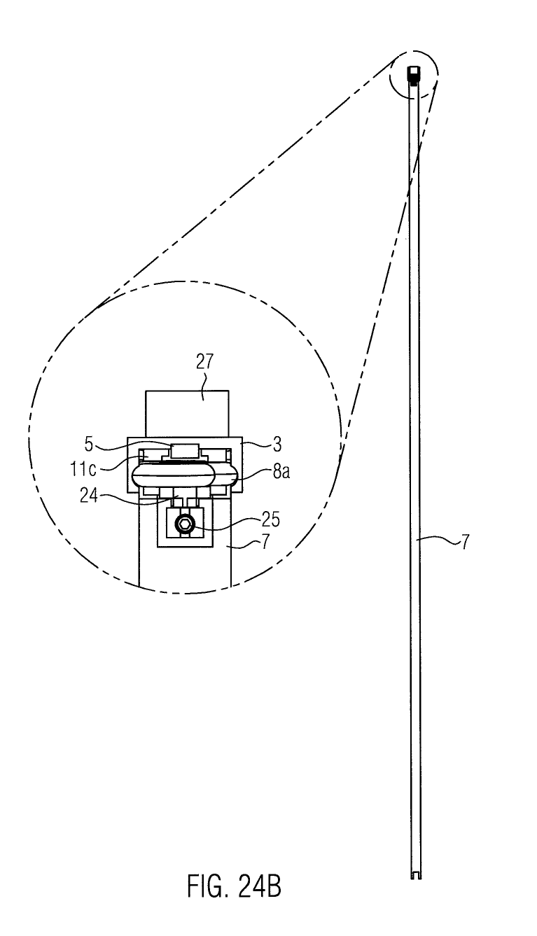

FIG. 24A schematically shows a sliding door with magnetic support according to a further embodiment of the present invention, in a front view.

In this embodiment, the guide 3 is fixed to the support A (not shown in the figure) on which the sliding door 1 is mounted, not parallel to the ground, but inclined with respect to the ground by a pre-determined angle β. This is made possible by the use of inclination means 27. The inclination means 27 can be wedge-shaped elements with variable thickness. They are positioned along the guide 3, on the side of the guide 3 facing the opposite side with respect to the door leaf 2 and in such a way that they all have the thicker side facing in the same direction. In particular, they can be advantageously arranged in such a way that the guide 3 is nearer to the ground on the side from which the sliding door is in the closed position. In this way, the inclination of the guide 3 with respect to the ground ensures that the door leaf 2 of the sliding door 1 automatically returns to the closed position after having been opened. The embodiment illustrated, therefore, is particularly advantageous if applied, for example, to the doors of a refrigerated counter. In this embodiment of the invention the guide 3 is in the shape of a U facing towards the ground. The guide 3 and the inclination elements 27 can be made in any material, both metallic and non-metallic, for example wood or plastic.

The door leaf 2 and the first coupling means 4 comprising the magnetic elements 6 are described in greater detail with reference to FIG. 24B.

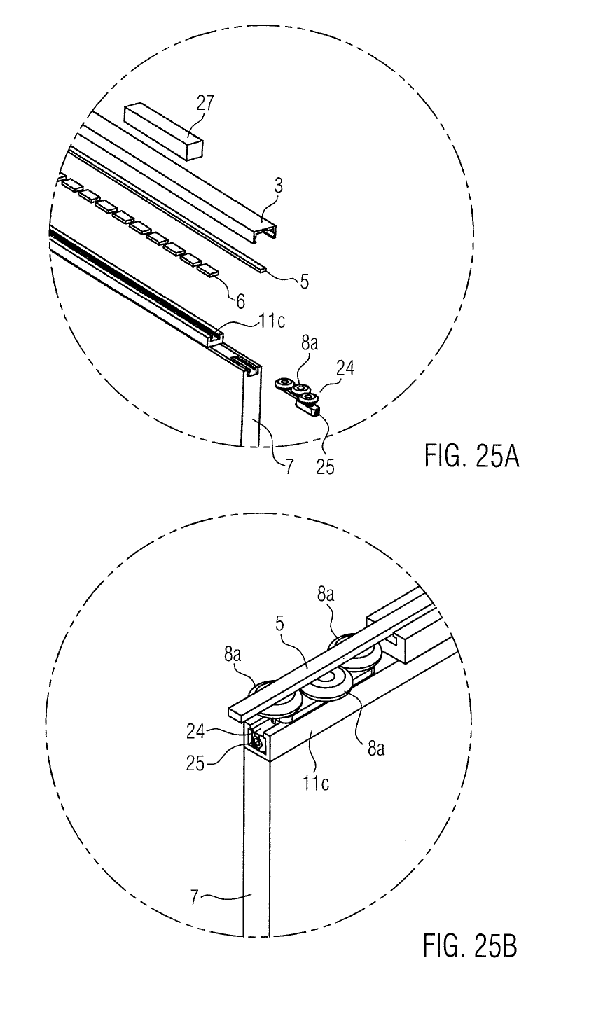

FIG. 24B shows the door of FIG. 24A, in a sectional view along a plane that is perpendicular to the sliding plane of the door leaf 2. It can be observed that the first coupling means 4 are positioned at the top end of the panel 7 of the door leaf 2. In the circle on the left in FIG. 24A, the first coupling means 4 and the second coupling means 5 are enlarged. The door leaf 2 comprises a single-block panel 7. It can be made of glass, wood, plastic or any other material that is suitable for the final use of the sliding door 1. The single-block panel 7 comprises, in its upper part, a section bar 11c (better visible in FIGS. 25A and 25B). The section bar 11c is fixed to the panel 7 of the door leaf 2 by using, for example, silicone, glue, screws or the like. The section bar 11c comprises a section formed by two parallelepipeds that are superimposed along their longer side. The upper parallelepiped, the one that is further from the ground, has a T-shaped cavity on its side facing towards the guide 3, so that the second coupling means 5 can slide inside it. The lower parallelepiped is solid and has two T-shaped cavities only at its side ends. These cavities are suited to house the first coupling means 4. The first coupling means 4 are mounted on the top end of the door leaf 2. In this embodiment of the invention the first coupling means 4 comprise a carriage 24 comprising the rolling means 8a, a projecting mobile element 26 (not visible in this figure, but clearly shown in FIGS. 25A, 25B, 27 and 28) and a dowel 25. The wheels 8a are positioned parallel to the ground and facilitate the relative movement of the door leaf 2 along the guide 3 during the opening and closing of the sliding door with magnetic support 1. They move in such a way as to rotate in contact with the side walls of the U-shaped guide 3. The mobile fixing element 26 is a tab that can remain within the carriage 24 or project from the same. The position of the mobile fixing element is adjusted by the dowel 25. When the dowel 25 is unscrewed, the mobile fixing element is within the carriage 24. When the dowel 25 is screwed, the mobile fixing element projects from the carriage 24. If the dowel 25 is screwed once the carriage 24 has been inserted in one of the T-shaped side cavities of the lower parallelepiped of the section bar 11c, the projecting element 26 projects, fixing the carriage 24 in position within the section bar 11c. The first coupling means, furthermore, comprise the magnetic elements 6. In the figure described, the magnetic elements 6, which are not visible because they are hidden by the rolling means 8a (the magnetic elements 6 are clearly visible in FIG. 25A), are positioned between the second coupling means 5 and the upper parallelepiped of the section bar 11c and have the shape of a parallelepiped. However, the magnetic elements 6 can also be in the shape of a cylinder, a cube, a disc or the like. In an alternative embodiment of the invention, the rolling elements 8a may comprise the magnetic elements 6. The wheels 8a can, for example, be cylindrical magnets. Alternatively, the surface of the rolling means 8a in contact with the second coupling means 5 can be covered with a magnetic material. In the embodiment shown, the second coupling means 5 comprise a foil fixed to the guide 3 and having such a profile that it slides inside the T-shaped cavity of the upper parallelepiped of the section bar 11c. This foil 5 can be made of a metallic material or a ferromagnetic material or a paramagnetic material, in such a way that it is affected by the magnetic force exerted by the magnetic elements 6. In order for the friction between the second coupling means 5 and the section bar 11c, which are kept in contact by the magnetic force exerted by the magnetic elements 6, to be as low as possible, the second coupling means 5 and/or the section bar 11c can be covered or entirely made with a material with a low friction coefficient, for example Teflon or self-lubricating plastics like Arnite, Vulcolon or POM. In particular, the surface of the section bar 11c that is in contact with the second coupling means 5 may comprise material with a low friction coefficient.

The magnetic elements 6 exert a magnetic force with respect to the second coupling means 5, so that the weight of the door leaf 2 is supported through this magnetic force. The rolling means 8a, if they do not comprise the magnetic elements 6, do not need to support the weight of the door leaf 2, and therefore are subject to very limited stress. In fact, once the door leaf 2 of the sliding door 1 has been placed in its seat, its weight is supported by the magnetic force exerted by the magnetic elements 6 on the second coupling means 5. The weight of the door leaf 2 is supported by the magnetic force over its entire stroke along the guide 3.

FIG. 25A schematically shows a 3D view of a detail of the sliding door with magnetic support shown in FIG. 24. In this figure it is possible to observe the section bar 11c, the carriage 24 before it is inserted in the section bar 11c, the magnets 6, the second coupling means 5, the guide 3 and the inclination means 27 of the guide 3.

FIG. 25B schematically shows a 3D view of a detail of the sliding door with magnetic support shown in FIG. 24. In this figure it is possible to observe the section bar 11c, the carriage 24 after it has been inserted in the section bar 11c and the second coupling means 5.

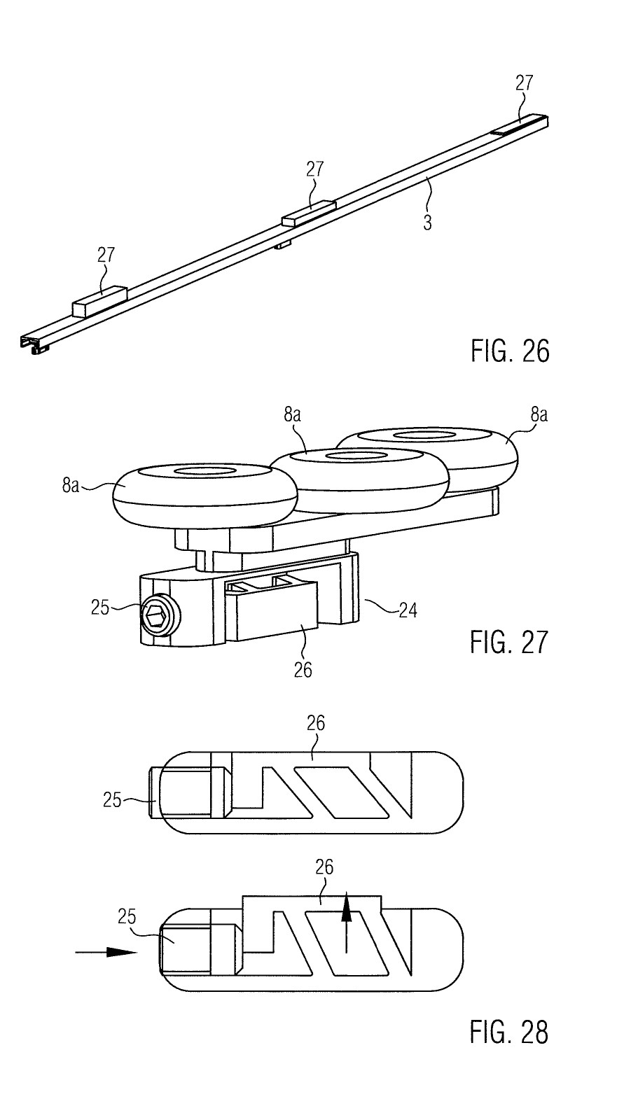

FIG. 26 schematically shows a 3D view of a detail of the sliding door with magnetic support shown in FIG. 24. In particular, the figure shows the guide 3 comprising the inclination elements 27.

FIG. 27 schematically shows a 3D view of a detail of the sliding door with magnetic support shown in FIG. 24. In particular, the figure shows the carriage 24. It is possible to observe the rolling means 8a, the dowel 25 and the mobile fixing element 26.

FIG. 28 schematically shows a detail of the sliding door with magnetic support shown in FIG. 24. In particular, the figure shows the carriage 24 seen from below. In the top panel the dowel 25 is not screwed and the mobile fixing element is within the carriage, while in the bottom panel the dowel 25 is screwed and the mobile fixing element projects from the carriage 24.

Even if the present invention has been described with reference to the embodiments illustrated above, it is clear to the expert in the art that it is possible to make several modifications, variants and improvements to the present invention in the light of the explanations provided above and within the scope of the attached claims, without departing from the subject and scope of protection of the invention.

For example, the shape of the first coupling means, of the second coupling means and of the magnetic elements can be properly modified according to the needs. Also the number of the magnetic elements of the first coupling means can be varied according to the needs.

Furthermore, the panel of the door leaf can be made in different kinds of materials, for example glass, wood, metal, plastic materials and the like. The panel of the door leaf can be of the single-block type or of the type with double glazing.

The door according to the present invention can be used both in the field of building construction, and therefore for the interiors or exteriors of buildings, and in the field of furniture, and therefore for different types of furnishing elements, for example wardrobes, cupboards, office furniture, shelves, fridges, shower cubicles, bathtubs and so on.

Finally, the fields of application that are considered known to the experts in the art have not been described herein, in order to avoid uselessly putting the illustrated invention in the shade.

Consequently, the invention is not limited to the embodiments described above, but is only limited by the scope of protection defined by the attached claims.

1. Sliding door (1) comprising a door leaf (2) and a guide (3) that allows said door leaf (2) to slide along said guide (3), wherein said sliding door (1) further comprises first coupling means (4) and second coupling means (5, 5′) suited to couple said door leaf (2) with said guide (3), characterized in that said first coupling means (4) comprise one or more magnetic elements (6) so as to exert a magnetic force (FM) between said first coupling means (4) and said second coupling means (5, 5′), so that the weight of said door leaf (2) is at least partially supported through said magnetic force (FM).

2. Sliding door (1) according to claim 1, characterized in that said magnetic force (FM) is of the attractive type.

3. Sliding door (1) according to claim 1, characterized in that said magnetic force (FM) is of the repulsive type, so that the weight of said door leaf (2) is at least partially supported through magnetic levitation.

4. Sliding door (1) according to any of the preceding claims, characterized in that said magnetic force (FM) comprises a vertical component (FM,//) parallel to the weight force (FP) of said door leaf (2) and a horizontal component (FM,^{⊥}) perpendicular to said vertical component (FM,//), wherein said horizontal component is different from zero in such a way as to stabilize said door leaf (2) during its sliding movement along said guide (3).

5. Sliding door (1) according to any of the preceding claims, characterized in that said first coupling means (4) and/or said second coupling means (5, 5′) are configured so that said one or more magnetic elements (6) are not in physical contact with said second coupling means (5).

6. Sliding door (1) according to any of the preceding claims, characterized in that said first coupling means (4) and/or said second coupling means (5, 5′) comprise material with a low friction coefficient, for example Teflon, so as to facilitate the sliding movement of said door leaf (2) along said guide (3).

7. Sliding door (1) according to any of the preceding claims, characterized in that said first coupling means (4) and/or said second coupling means (5, 5′) comprise one or more rolling elements (8, 8′, 8″, 8a), for example wheels, so as to facilitate the sliding movement of said door leaf (2) along said guide (3).

8. Sliding door (1) according to claim 7, characterized in that said first coupling means (4) comprise said one or more rolling elements (8, 8′, 8″, 8a) and said one or more rolling elements (8, 8′, 8″, 8a) comprise said one or more magnetic elements (6).

9. Sliding door (1) according to claim 7 or 8, characterized in that said guide (3) comprises a raceway (23) suited to house said rolling means (8, 8′, 8″) during the sliding movement within said guide (3).

10. Sliding door (1) according to any of the preceding claims, characterized in that said second coupling means (5, 5′) comprise one or more cavities or one or more slits suited to house said magnetic elements (6) of said first coupling means (4) during the sliding movement.

11. Sliding door (1) according to any of the preceding claims, characterized in that said door leaf (2) comprises elastic elements (15) suited to automatize the opening and/or closing of said sliding door (1).

12. Sliding door (1) according to any of the preceding claims, characterized in that said door (1) further comprises shock-absorbing elements (16) suited to slow down the sliding movement of said door leaf (2) along said guide (3) during the opening and/or closing of said sliding door (1).

13. Sliding door (1) according to any of the preceding claims, characterized in that said door (1) comprises safety means (13; 14a; 14b) suited to limit the downward movement of said door leaf (2), so as to prevent said door leaf (2) from slipping out of said guide (3).

14. Sliding door (1) according to claim 13, characterized in that said safety means are of the skirt type (13) and comprise a plate that can slide with respect to said door leaf (2) in such a way as to project from said door leaf (2) at variable heights, so that it is possible to adjust the maximum distance between the lower end of said door leaf (2) and the ground.

15. Sliding door (1) according to claim 13 or 14, characterized in that said guide (3) comprises a projecting element (14a) that can be inserted in a cavity (14b) made in said first coupling means (4), so that said door leaf (2) does not slip out of its seat and does not move downwards.

16. Sliding door (1) according to one of the preceding claims, characterized in that said first coupling means (4) comprise a carriage (24) comprising rolling means (8a).

17. Use of one or more magnetic elements (6, 8, 8′, 8a) in a sliding door (1) comprising a door leaf (2) and a guide (3), allowing said door leaf (2) to slide along said guide (3) in such a way as to generate a magnetic force (FM) suited to support the weight of said door leaf (2).

18. Door kit, said kit comprising one or more magnetic elements (6, 8, 8′, 8a) and a guide (3) comprising coupling means (5), wherein said one or more magnetic elements (6) are suited to be fixed to the leaf of said door and said guide (3) is suited to be fixed to the frame of said door, so that said door leaf can slide along said guide (3) and so that the magnetic force (FM) exerted by said magnetic elements (6, 8, 8′, 8a) on said coupling means (5) at least partially supports the weight of said door leaf.

19. Furnishing element, like for example a wardrobe, a cupboard, a piece of office furniture, a fridge, a shower cubicle, a bathtub, said furnishing element comprising a sliding door, characterized in that said sliding door is made according to any of the claims from 1 to 17.
